(19) United States
(12) Patent Application Publication
(10) Pub. No.: US 2013/0114924 A1
(43) Pub. Date: May 9, 2013

(54) Optical Arrangement and a Method of Forming the Same

(71) Applicants: Ter-Hoe Loh, Singapore (SG); Seng-Tiong Ho, Singapore (SG); Yingyan Huang, Singapore (SG)

(72) Inventors: Ter-Hoe Loh, Singapore (SG); Seng-Tiong Ho, Singapore (SG); Yingyan Huang, Singapore (SG)

(73) Assignee: AGENCY FOR SCIENCE, TECHNOLOGY AND RESEARCH, Singapore (SG)

(21) Appl. No.: 13/695,142

(22) PCT Filed: Apr. 26, 2011
(86) PCT No.: PCT/SG2011/000162

§ 371 Date: Jan. 14, 2013

Related U.S. Application Data
(60) Provisional application No. 61/329,249, filed on Apr. 29, 2010.

(51) Int. Cl. G02B 6/32; G02B 6/12

(52) U.S. Cl. CPC G02B 6/32; G02B 6/12
USPC 385/14; 385/33; 427/163.2; 216/26; 205/122

(57) ABSTRACT

According to embodiments of the present invention, an optical arrangement is provided. The optical arrangement includes a support substrate; at least one optical fiber arranged on the support substrate; at least one waveguide arranged on the support substrate and adjacent to the at least one optical fiber; the at least one waveguide defining a light propagation direction; and at least one grin index lens arranged asymmetrically relative to the light propagation direction such that light is coupled from the at least one optical fiber through the at least one grin index lens to the at least one waveguide.

### CROSS-REFERENCE TO RELATED APPLICATION

This application claims the benefit of priority of U.S. provisional application No. 61/329,249, filed 29 Apr. 2010, the content of it being hereby incorporated by reference in its entirety for all purposes.

### TECHNICAL FIELD

Various embodiments relate to an optical arrangement and a method of forming the optical arrangement.

### BACKGROUND

Various approaches have been suggested by various research groups to address the problem of mode-size transformation of single mode fiber to nano-photonic waveguides on photonic integrated circuit (PIC). For example, one method was using a silicon (Si) up-taper, fabricated by using grey scale photolithography and dry etching of Si on silicon-on-insulator (SOI). Although such Si up-taper showed coupling efficiency as high as 90%, and single mode fiber optical mode can be coupled to sub-micron dimension, it has several disadvantages. Namely, the Si up-taper is long in the order of 500˜1000 μm. These consume or take up a lot of Si real-estate (i.e. space) on the chip. Furthermore, the fabrication process has to start with a relatively thick SOI with a thickness of ˜10 μm, and a device wafer has to be supported by a larger handle wafer underneath.

Another approach was to use Si down (reverse) taper. Although the Si down-taper is potentially compact with taper length in the order of 40˜50 μm, low loss operation of the Si down-taper requires the bottom cladding oxide to be thick with a thickness of at least 2 μm. In addition, optimal low coupling loss for quasi-TM mode dictates that the nano-tip of the down-taper has to have a tip width of about 50 nm. This requirement of thick bottom cladding oxide or thick buried oxide when the device is fabricated on SOI is in conflict with certain requirements of electronics which require a thinner buried oxide thickness if electronics circuits are to be built on the same platform.

In addition, other approaches and methods that have been used to perform optical mode size transformation do not meet the requirements for optical mode size transformation from a single mode fiber to sub-0.5 μm sized nano-waveguides.

In addition, considerations should be given to the current optoelectronic modules which include a single mode optical fiber, a semiconductor diode laser or photo-detector element(s) and any interposing coupler elements, which are all integrated on a common module platform, and the fiber-to-chip alignment (i.e. the optical alignment) method therein. Conventionally, there are two main approaches, namely active alignment and passive alignment, to couple an optical fiber to a waveguide in a photonic chip.

In active alignment, optical components are turned on in power while alignment is being done by specialized assemblers to align optical fibers to sub-micron tolerances. For example, discrete focusing lens (e.g. ball-lens) placed on an optical module platform has been popularly used to couple a laser diode to a waveguide on a photonic chip. The disadvantage of such a method is that it is expensive, due to the large amount of equipment capital. In addition, processes are needed to perform active alignment for every fiber-pigtailed optoelectronics components fabricated.

In passive alignment, no activation of optoelectronic components is needed. An optical fiber is picked, and placed on an optoelectronic platform and self-aligned to an optoelectronic component. If passive alignment can be achieved, the overall cost of manufacturing such a component is greatly reduced.

In the past two decades at least before 2004, most of the fiber-pigtailed optoelectronics modules have been fiber-connected to discrete active devices such as diode lasers and photo-detectors. The optical coupling elements to connect the laser, for instance, to single mode fibers (SMFs) have taken various forms. These include microlens fabricated on the SMF, discrete lenses and GRIN rods and others. Use of ball-lens usually resulted in low coupling efficiency because of its low numerical aperture (NA) and spherical aberration of the ball-lens. For these cases, the active alignment method was utilized. This resulted in high cost for the packaging and high power dissipation. Packaging cost was later reduced with the use of discrete GRIN rod lens and/or the use of passive alignment on an Si optical bench. The Si optical bench offers the use of V-groove fabricated by anisotropic wet etching of Si substrate for the placement of the discrete components on the Si optical bench. The disadvantage is that it requires the use of two types of V-groove on the same platform and that the coupling components are discrete in nature. Fabrication of Si sub-mount can also be complicated. In addition, coupling SMF to semiconductor laser with an optical spot size in the order of about 1 μm or sub-micron sizes requires not just the capability of passive alignment, but also matching of the optical spot sizes between the SMF and the laser source so that alignment tolerance can be achieved.

In another method, multimode fibers (MMFs), discrete GRIN rod lens on U-groove for passive alignment to interface the semiconductor laser to the SMF was proposed. MMF was used because its tolerance to misalignment to the laser is large. However, such combination of components resulted in fabrication complexity.

In recent years, in the advent of electronics/photonics integrated circuits (EPIC) on-a-chip that are built on an SOI substrate or InP substrate, methods were needed to connect the SMF to such an EPIC chip. Recent proposed methods include using Si-photonic 1-D gratings on the Si-photonic chip, or 2-D grating holes on the Si-photonic chip. In these methods, the SMF is vertically butt-coupled to the surface of the chip. Using the same Si-photonic grating, the SMF can also be side-coupled to the chip using optical reflection of angled-tip optical fiber which is laid on top of the Si photonic grating. However, optical reflection of angled-tip optical fiber adds an extra disadvantage of optical power reduction prior to coupling to the chip.

### SUMMARY

According to an embodiment, an optical arrangement is provided. The optical arrangement may include a support substrate; at least one optical fiber arranged on the support substrate; at least one waveguide arranged on the support substrate and adjacent to the at least one optical fiber; the at least one waveguide defining a light propagation direction; and at least one grin index lens arranged asymmetrically relative to the light propagation direction such that light is coupled from the at least one optical fiber through the at least one grin index lens to the at least one waveguide.

According to an embodiment, a method of forming an optical arrangement is provided. The method of forming an optical arrangement may include forming at least one optical fiber on a support substrate; forming at least one waveguide on the support substrate and adjacent to the at least one optical fiber; forming at least one grin index lens asymmetrically relative to a light propagation direction within the at least one waveguide and further between the at least one optical fiber and the at least one waveguide such that light is coupled from the at least one optical fiber through the at least one grin index lens to the at least one waveguide.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic block diagram of an optical arrangement, according to various embodiments.

FIG. 2 shows a flow chart illustrating a method of forming an optical arrangement, according to various embodiments.

FIG. 3 shows a schematic diagram of an optical arrangement with a SuperGRIN lens integrated with a silicon (Si) waveguide on a photonic integrated circuit (PIC), according to various embodiments.

FIG. 4A shows a cross-sectional view of an optical arrangement with a SuperGRIN lens formed on a waveguide, according to various embodiments.

FIG. 4B shows a cross-sectional view of an optical arrangement with a SuperGRIN lens formed on an underlying buried oxide layer, according to various embodiments.

FIG. 5A shows a process flow of fabricating a SuperGRIN lens integrated on a silicon photonic waveguide, according to various embodiments.

FIG. 5B shows a process flow of strengthening an interface between a SuperGRIN lens and a metallic etch stop layer, according to various embodiments.

FIG. 6 shows a process of fabricating a SuperGRIN lens on a Si-photonic waveguide, according to various embodiments.

FIG. 7 shows a generalized process flow of fabricating a SuperGRIN lens on a Si-waveguide, according to various embodiments.

FIG. 8 shows a process of forming a metallic hard-mask, according to the embodiment of FIG. 5A.

FIG. 9 shows a process of fabricating a SuperGRIN lens on a Si-photonic waveguide, according to various embodiments.

FIG. 10A shows a cross-sectional view of an optical arrangement incorporating a passive alignment scheme for alignment of a single mode optical fiber to a SuperGRIN lens on a PIC integration platform, according to various embodiments.

FIG. 10B shows a plot illustrating additional coupling loss against vertical misalignment between the fiber core and the SuperGRIN lens, based on the embodiment of FIG. 10A.

FIG. 11 shows a process flow of integrating a SuperGRIN lens on a photonic waveguide to a V-groove, according to various embodiments.

FIG. 12 shows a process of fabricating a SuperGRIN lens on a photonic waveguide integrated with a V-groove, according to various embodiments.

FIG. 13 shows a schematic perspective view of a PIC chip on a PCB substrate, according to various embodiments.

FIGS. 14A to 14F show different views of an EPIC-Fiber Optical Module, according to various embodiments.

FIG. 15A shows an exploded perspective view of an EPIC chip configured to interface with a multi-port optical module, according to various embodiments.

FIG. 15B shows a cross-sectional view taken along the line A-A′ of the embodiment of FIG. 15A, when the EPIC chip is assembled.

FIG. 16 shows a cross-sectional view of an EPIC chip configured to interface with a multi-port (multi-fiber) optical module, according to various embodiments.

FIG. 17A shows a cross-sectional view of an EPIC chip configured to interface with a multi-port (multi-fiber) optical module, according to various embodiments.

FIG. 17B shows different views of an optical fiber of the embodiment of FIG. 17A.

FIG. 18 shows a process of integrating a SuperGRIN lens on a photonic waveguide to a V-groove, according to various embodiments.

FIG. 19 shows a schematic diagram of a vertical cross-section of a SuperGRIN lens integrated to a Si-waveguide on an SOI substrate, according to various embodiments employing. CMOS-compatible processes.

FIGS. 20A and 20B show scanning electron micrographs of a SuperGRIN lens integrated to a Si-waveguide on an SOI substrate, fabricated by a CMOS compatible process, according to various embodiments. The respective scale bar represents 10 μm.

FIG. 21 shows optical output images of optical modes from a 6 μm-wide termination Si-waveguide without a SuperGRIN lens, and from a 6 μm-wide termination Si-waveguide with a SuperGRIN lens butt-terminated to the waveguide. The scale bar represents 5 μm.

FIG. 22 shows a plot of Fabry-Perot spectra of a 3 μm-width Si-waveguide, using lens objectives to couple light into/out of the Si-waveguide.

FIG. 23 shows a plot of insertion-loss spectrum of a 3 μm-wide and 2228.5 μm-long Si-waveguide, using lensed fiber-probes to couple light into/out of the Si-waveguide.

FIG. 24 shows a plot of insertion-loss spectrum of a 3 μm-wide Si-waveguide with a 500 μm-long Si-up-taper at the output and butt-terminated with a SuperGRIN lens. A lensed fiber-probe was used for input-coupling and an SMF28 was used for output-coupling.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Various embodiments may provide an optical arrangement and a method of forming the optical arrangement to realize an optical mode-size-transformer on a chip, for transforming an optical mode from an optical fiber to an optical mode having a size of sub-0.5 μm, which is compatible with existing electronics integrated-circuit (IC) manufacturing process (i.e. capable of mass production on Si-wafers) and also able to focus light to a sub-0.5 μm dimension, without or with reduced at least some of the associated disadvantages of the current approaches.

Various embodiments relate to the field of integrated photonics, and in particular relate to coupling of light from a single mode optical fiber (e.g. having an optical mode size of approximately 9-10 μm), to an on-chip photonic nano-waveguide with a sub-wavelength optical mode size (e.g. <0.5 μm), and also optical coupling in the opposite coupling direction, so as to achieve a fiber-to-chip optical module, utilizing optical fiber passive alignment.

Various embodiments may provide an optical arrangement or an apparatus including strong graded index nano-waveguide optical couplers and a method of making such optical arrangement.

Various embodiments may provide an optical arrangement and a method of making an integration platform of optical-fiber coupled to a photonics integrated-circuit (IC) chip by passive alignment via an ultra-compact bi-material multilayer SuperGRIN lens which is co-integrated with the devices or components on the same photonic IC chip.

Various embodiments may provide an electronics/photonics integrated circuits (EPIC)-module using passive alignment.

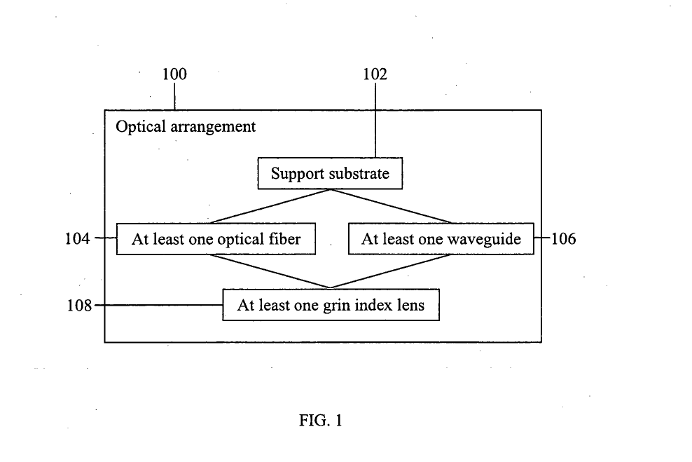

FIG. 1 shows a schematic block diagram of an optical arrangement 100, according to various embodiments. The optical arrangement 100 includes a support substrate 102, at least one optical fiber 104 arranged on the support substrate 102, at least one waveguide 106 arranged on the support substrate 102 and adjacent to the at least one optical fiber 104, the at least one waveguide 106 defining a light propagation direction, and at least one grin index lens 108 arranged asymmetrically relative to the light propagation direction such that light is coupled from the at least one optical fiber 104 through the at least one grin index lens 108 to the at least one waveguide 106.

The at least one grin index lens 108 may include a multi-layer structure of at least two different layers with a difference in refractive index such that the at least one grin index lens 108 is configured to allow a variation in the difference in refractive index to achieve a desired focus spot size so as to enable coupling of an optical mode in the at least one optical fiber 104 to the at least one waveguide 106.

The at least one waveguide 106 may include a refractive index same or substantially the same as the refractive index of one of the at least two different layers. The at least two different layers may include a combination of materials selected from a group consisting of silicon and silicon oxide, silicon and hafnium oxide, and silicon and titanium oxide.

The optical arrangement 100 may further include an insulating layer arranged on the support substrate 102. The at least one waveguide 106 may be arranged on the insulating layer. The at least one grin index lens 108 may be arranged over the at least one waveguide 106 or the at least one grin index lens 108 may be arranged at one end of the at least one waveguide 106 and further arranged directly on the insulating layer. The insulating layer may be a buried oxide layer.

In various embodiments, the at least one grin index lens 108 may have a parabolic or near-parabolic refractive index profile. The at least one waveguide 106 may include an up-tapered waveguide. The at least one waveguide 106 may include a decreasing cross-sectional dimension in a direction away from the at least one grin index lens 108.

In various embodiments, the at least one optical fiber 104 may be a single mode fiber. The at least one optical fiber 104 may include a core portion and a cladding portion. The at least one grin index lens 108 may be arranged along a same axis as the core portion of the at least one optical fiber 104.

In various embodiments, the support substrate 102 may include at least one first groove. The at least one optical fiber 104 may be positioned in the at least one first groove so as to allow an optical alignment of the at least one optical fiber 104 to the at least one grin index lens 108. The at least one first groove may include a V-shape groove or a U-shape groove.

In various embodiments, the optical arrangement 100 may further include a capping substrate. The capping substrate may include at least one second groove. The at least one first groove may correspond to the at least one second groove when the capping substrate is positioned over the support substrate 102. The at least one second groove may include a V-shape groove or a U-shape groove.

The optical arrangement 100 may further include at least one interconnect arranged between the capping substrate and the support substrate 102, where the at least one interconnect is configured to secure the at least one optical fiber 104 in a desired position between the capping substrate and the support substrate 102. The at least one interconnect may include at least one of a flip-chip bump, a snap adhesive, or a combination of a polymer and a metal strip. In various embodiments, the at least one optical fiber 104 may include at least one third groove configured to accommodate the metal strip to secure the at least one optical fiber 104.

In various embodiments, the capping substrate comprises a metallic substrate. The metallic substrate may be Kovar.

In various embodiments, the optical arrangement 100 may further include at least one wire bond pad arranged on the support substrate 102. The optical arrangement 100 may further include an electronics-photonics integrated circuit, wherein the at least one waveguide 106 is optically coupled to the electronics-photonics integrated circuit.

In various embodiments, the support substrate 102 may include a semiconductor layer. The semiconductor layer may include silicon and/or III-V materials.

In various embodiments, the desired focus spot size is less than 0.5 μm.

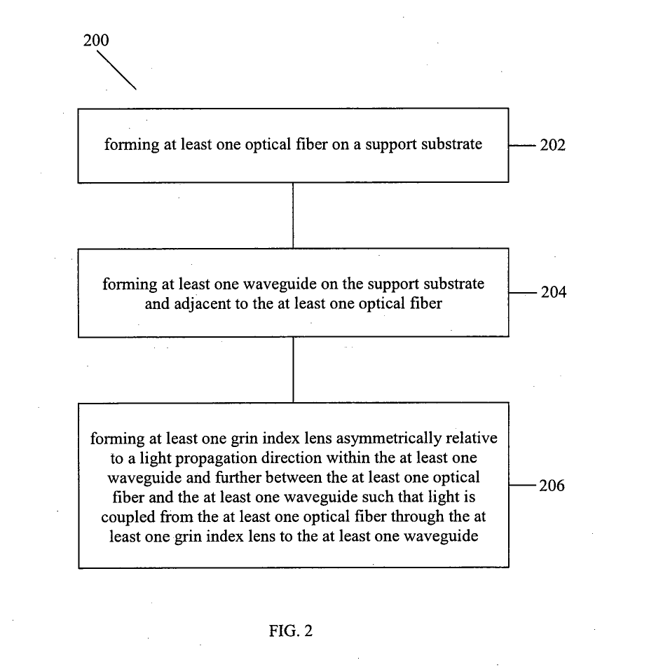

FIG. 2 shows a flow chart 200 illustrating a method of forming an optical arrangement, according to various embodiments.

At 202, at least one optical fiber is formed on a support substrate.

At 204, at least one waveguide is formed on the support substrate and adjacent to the at least one optical fiber. This may include forming at least one waveguide layer on the support substrate, and patterning the at least one waveguide layer to form the at least one waveguide.

At 206, at least one grin index lens is formed asymmetrically relative to a light propagation direction within the at least one waveguide and further between the at least one optical fiber and the at least one waveguide such that light is coupled from the at least one optical fᵢber through the at least one grin index lens to the at least one waveguide.

In various embodiments, the process for forming the at least one grin index lens may include forming a first masking layer on at least one grin index lens structure, forming a first photoresist layer with a desired pattern on the first masking layer, patterning the desired pattern of the first photoresist layer onto the first masking layer; and removing portions of the first masking layer and the at least one grin index lens structure not covered by the first photoresist layer.

In various embodiments, patterning the desired pattern of the first photoresist layer onto the first masking layer may include dry etching by argon/chlorine reactive ion beam etching.

In various embodiments, the first masking layer may include a metallic hard mask layer. The first masking layer may include a material selected from a group consisting of Ni/Ti, Cr/Ti, Al/Ni/Ti, and Cr. The first photoresist layer may include a positive photoresist layer.

In various embodiments, the process for forming the at least one grin index lens may include forming a second photoresist layer with at least one opening on at least one grin index lens structure, forming a second masking layer into the at least one opening; and removing the second photoresist layer and portions of the at least one grin index lens structure not covered by the second masking layer.

In various embodiments, forming the second masking layer into the at least one opening may include electroplating the second masking layer into the at least one opening.

In various embodiments, the second masking layer may include nickel. The second photoresist layer may include a negative photoresist layer.

In various embodiments, forming the at least one grin index lens may further include forming the at least one grin index lens structure over the support substrate and in contact with the at least one waveguide. Forming the at least one grin index lens structure over the support substrate and in contact with the at least one waveguide may include depositing a plurality of a pair of two different layers with a difference in refractive index in an alternating sequence over the support substrate.

In various embodiments, removing portions of the first masking layer and the at least one grin index lens structure not covered by the first photoresist layer may include etching using etchant gases with a substantially equal etch rate of the pair of two different layers.

In various embodiments, removing the second photoresist layer and portions of the at least one grin index structure not covered by the second masking layer may include etching using etchant gases with a substantially equal etch rate of the pair of two different layers.

In various embodiments, the etchant gases may include at least one of a SF₆, CH₃, CF₄, C₄F₈, Ar, and O₂.

In various embodiments, the method may further include forming an etch stop layer over the support substrate.

In various embodiments, the method may further include providing heat treatment after depositing a first of the plurality of the pair of two different layers. In various embodiments, providing heat treatment may include performing rapid thermal annealing for silicidation of the first of the pair of two different layers with the etch stop layer.

Various embodiments may include the use of a high refractive-index contrast bi-material multilayer structure to form an on-chip GRIN lens in an optical arrangement. In various embodiments, an optical arrangement may be provided, utilizing a multilayer bi-material (e.g. silicon/silicon dioxide (Si/SiO₂)) superhigh numerical aperture (NA) gradient index (GRIN) lens asymmetrically placed on a silicon (Si) nano-waveguide (e.g. a GRIN lens placed on a waveguide) to couple an optical mode in the single mode fiber to the Si nano-waveguide on a photonic integrated circuit (PIC). The high index contrast of Si/SiO₂ in the multilayer lens structure may provide a focused spot size of approximately 0.5 μm or less (i.e. ≦0.5 μm), which is smaller than that of, for example, a multilayer structure with a silicon dioxide/titanium dioxide (SiO₂/TiO₂) combination. This is because the use of high index contrast materials of Si/SiO₂ in a bi-material multi-layer GRIN lens shows, by simulation, that the focused spot sized is sub-0.5 μm for about the same GRIN lens with a ¼-pitch length.

In contrast, conventional approaches provide low refractive index contrast materials in a bi-material multilayer GRIN lens. In addition, the GRIN lens is placed symmetrically such that the waveguide (e.g. nano-waveguide) is placed at the center of the GRIN lens. The focused spot size that is obtained is approximately 0.5 μm to 0.7 μm or more.

In various embodiments, the thicknesses of the layers and the effective refractive index profile of the bi-material GRIN lens (e.g. having alternating layers of Si and SiO₂) may have various dimensions and forms respectively. In various embodiments, the GRIN lens has an at least substantially asymmetrical refractive index profile along a height or thickness of the lens, with a maximum refractive index near the top of the lens, varying along the profile to a minimum refractive index at the bottom of the lens in contact with a nano-waveguide or a buried oxide. For example, the refractive index profile may follow at least a substantially parabolic profile, bell curve profile, Gaussian profile or other suitable profiles. In addition, the GRIN lens may have a refractive index profile that enables aberration free optical beam transformation.

In the context of various embodiments, other high index-contrast bi-material combinations that may be used include silicon/hafnium oxide (Si/HfO₂), silicon/aluminium oxide (Si/Al₂O₃), silicon/titanium dioxide (Si/TiO₂) or silicon with any dielectric material, preferably an oxide, which has a material refractive index significantly different from the refractive index of Si.

In the context of various embodiments, the silicon layers of the SuperGRIN lens multi-layer structure may be amorphous silicon (i.e. a-Si or α-Si).

Conventionally, “high refractive index contrast” arises from the use of bi-material to form an optical waveguide with the refractive index of the core material higher than that of the cladding material. Bi-material is considered “high index contrast” when the physical dimension of the waveguide are sub-microns to achieve single mode operation of the waveguide.

In the context of various embodiments, a multilayer structure of high refractive-index contrast bi-material (e.g. Si/SiO₂) is used to form a GRIN lens. The high index contrast between Si/SiO₂ is achieved from the use of Si, which is a semiconductor and has a high refractive index of about 3.46, which is significantly different from that of dielectric SiO₂ with a refractive index of about 1.46. Therefore, the refractive index difference is approximately 2. This high index difference, when used to form a Si/SiO₂-SuperGRIN lens enables the lens to have a focused spot size of approximately 0.26 μm to approximately 0.5 μm. In contrast, the bi-material dielectrics TiO₂/SiO₂ has a refractive index difference of about 0.9, where the simulated focused spot size was about 0.53 μm to 0.7 μm. If an asymmetric structure for TiO₂/SiO₂ is used, the focused spot size may be larger. Generally, a bi-material refractive index difference larger than about 1.0 may be considered a high refractive index contrast.

For a small focused spot size, in addition to the requirement that the refractive index difference in the bi-material should be high, the absolute value of the refractive index of the high-index material should be equal or near to the refractive index of the waveguide that guides the light-wave into the SuperGRIN lens. Hence, the high-index material should preferably be a semiconductor, where the optical waveguide is a semiconductor. Accordingly, various embodiments provide a Si waveguide, which is of the same material for the high-index material of the bi-material combination for fabricating the SuperGRIN lens. This requirement arises from the asymmetric placement or arrangement of the SuperGRIN lens on the waveguide.

In various embodiments, the arrangement(s) or structure(s) of a bi-material (e.g. Si/SiO₂) multilayer GRIN lens asymmetrically placed on a nano-waveguide is provided. The GRIN lens may be asymmetrically placed on or over a nano-waveguide (e.g. a nano-waveguide placed at least substantially at one end of the GRIN lens, e.g. in contact with a bottom surface of the GRIN lens). Alternatively, the GRIN lens may be asymmetrically placed on a buried oxide, with a nano-waveguide in contact with a side surface of the GRIN lens (e.g. a buried oxide layer in contact with a bottom surface of the GRIN lens, with the GRIN lens butt-coupled to a waveguide).

In addition, various embodiments provide one or more methods of fabricating a multilayer Si/SiO₂ GRIN lens on a photonic integrated circuit chip (i.e. the process integration flow to achieve such a structure). The method or methods may provide forming a multilayer GRIN lens asymmetrically placed on a nano-waveguide or a buried oxide. The method of forming the asymmetrical GRIN lens on a Si-waveguide enjoys the advantage of ease of fabrication. In various embodiments, a multilayer Si/SiO₂ GRIN lens may be fabricated by thin films deposition, patterning by photolithography and dry etching of Si/SiO₂ multilayer. The layers of Si and SiO₂ may be deposited by dual-beam ion-assisted physical deposition. In addition, Si and SiO₂ are CMOS compatible material readily available for process integration in a CMOS foundry environment. Therefore, the fabrication processes are CMOS compatible.

In view of the stringent requirement to realize the SuperHigh NA lens structure of various embodiments (i.e. the SuperGRIN lens), the arrangement and processes of various embodiments to realize an asymmetric multilayer GRIN lens on chip may incorporate one or more of the following: the use of a vertical side-wall nickel (Ni) hard-mask for etching of approximately 7 μm-12 μm of Si/SiO₂ multilayer; an ICP/RIE etching method to achieve 1:1 selectivity (i.e. substantially equal etch rate) of the bi-material (e.g. Si:SiO₂) of the GRIN lens; the use of an embedded etch stop layer (e.g. a metallic or metal oxide layer) beneath the multilayer GRIN lens; and the use of a silicidation rapid-thermal annealing (RTA) process to strengthen the interface between the Si/SiO₂ multilayer and a bottom passivation oxide layer covering the Si-waveguide to prevent pre-matured peeling of the multilayer Si/SiO₂ GRIN lens.

Various embodiments may provide a method or a physical arrangement of structures to achieve passive alignment of one or more single mode optical fibers to the multilayer Si/SiO₂ GRIN lens, which couples light to the rest of the PIC (e.g. to other components on the PIC). The passive alignment method is used to achieve the required alignment accuracy within the tolerable range of the multilayer Si/SiO₂ GRIN lens.

Conventionally, fiber-pigtailed opto-package component consists of fiber-to-discrete optoelectronic semiconductor device, with active alignment, resulting in high cost and added extra component in the system.

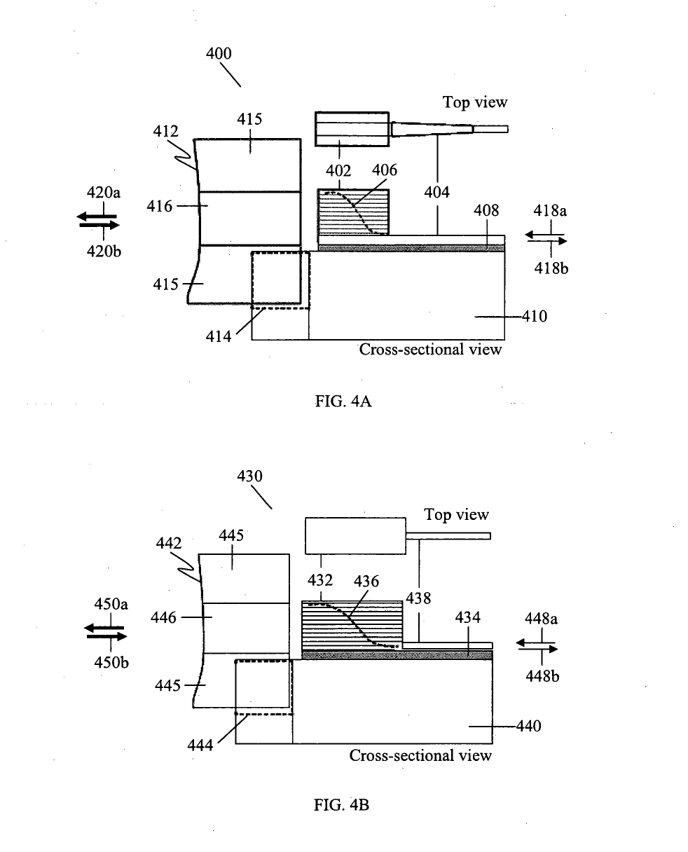

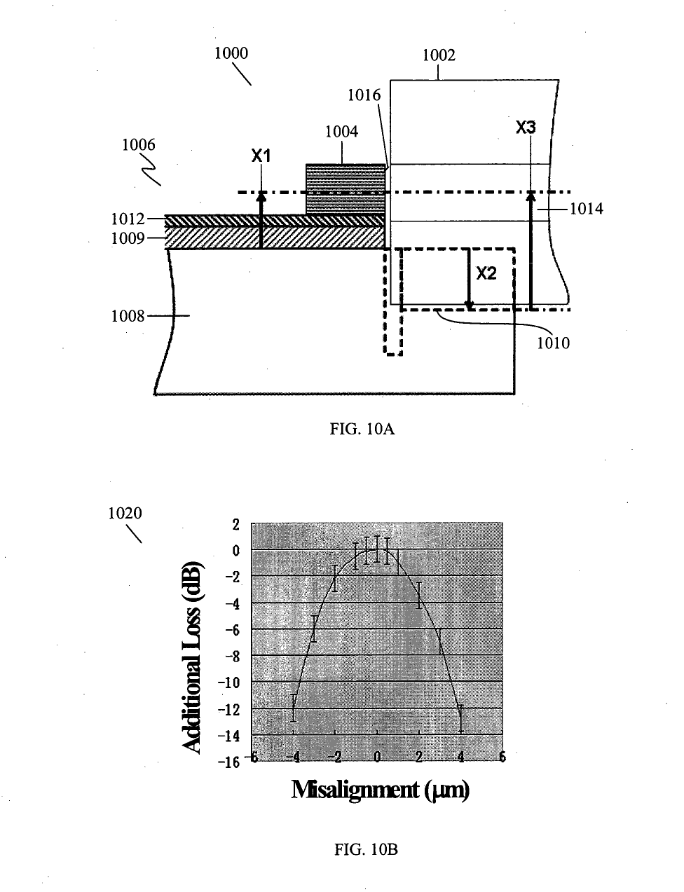

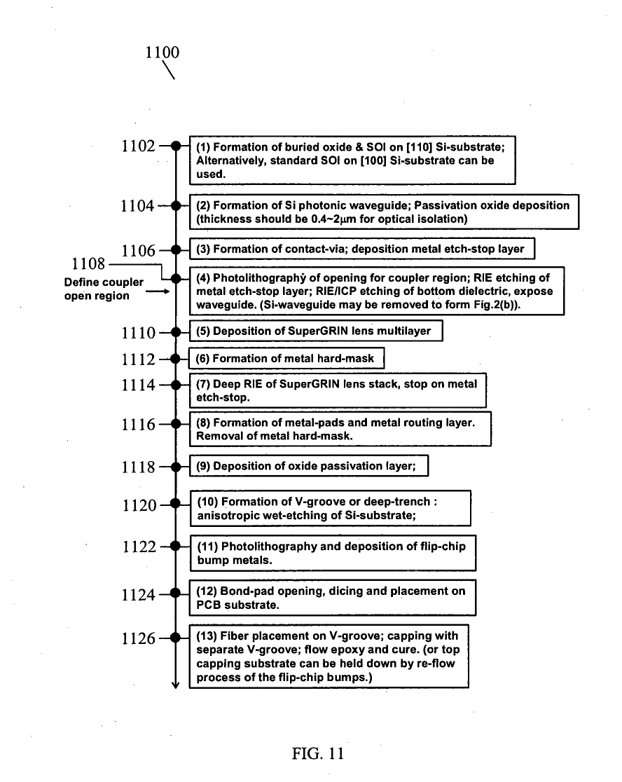

Various embodiments provide passive alignment onto an integration platform, e.g. passive alignment of single mode-fiber-to-EPIC chip. This enables a monolithic integration of active optoelectronic and passive photonic components, including but not limited to, light-source, detector, waveguide, and waveguide-based diode-laser, together with the SuperGRIN lens coupler of various embodiments, as well as other structures such as V-grooves, on the same chip. These components or devices may be built on a Si optical bench as the integration platform, and optical fibers may be attached to the integration platform by passive alignment, for example as shown in the embodiments of FIGS. 4A, 4B and 10A, for the alignment of a single mode-fiber to an optoelectronic/photonic chip. Therefore, various embodiments may provide an integration process to form the SuperGRIN lens on the same chip platform as the V-groove and the Si-waveguide. Subsequently, active diode-lasers and photo-detectors may be fabricated on the same platform.

In various embodiments, the on-chip SuperGRIN lens functions as a coupling element of a waveguide to a single mode fiber to enable passive alignment. Each optical fiber may be placed on the integration platform chip on a V-groove, for example fabricated by anisotropic wet etching, or a U-groove for example fabricated by a combination of dry and wet etchings, or a U-trench for example fabricated by deep reactive ion etching (RIE). The V-groove, the U-groove or the U-trench is also integrated on the same platform to provide passive alignment of the optical fiber to the integration platform chip. Such an arrangement may also allow an array of optical fibers to be butt-coupled to an array of SuperGRIN lenses on the platform. On the Si optical bench, III-V-epitaxy-on-Si may be used for active devices. In various embodiments, such a passive alignment method may also be extended to purely III-V substrate (e.g. InP or GaAs, or GaN) PIC. The alignment method of various embodiments advantageously is a key low cost enabler to make the final single mode-fiber-pigtailed integrated optoelectronic/photonic module low cost and commercially viable.

Various embodiments also provide methods and processes of tying down or securing one or more single mode optical fibers to an optical module or an electronic/photonic IC platform (i.e. integration of fiber to PIC platform), in order to achieve the required passive alignment accuracy. One method is the use of a capping substrate with or without any V-grooves, and with the use of flip-chip bumps to bond the capping substrate onto a corresponding bottom substrate. The capping substrate may be of a metallic material such as Kovar, which is an alloy of iron-nickel-cobalt, which has a thermal expansion coefficient substantially similar to that of a borosilicate glass. Another method is to tie-down the fiber on a V-groove using a flexible metallic strip. This has the flexibility of alignment adjustment prior to fixing the tied-down fiber permanently by flip-chip bonding.

PCT Application No PCT/SG2011/000048 provides embodiments of the SuperGRIN lens that may be used, the entire disclosure of which is incorporated herein by reference.

In the context of various embodiments, the terms “grin index lens”, “GRIN lens”, and “SuperGRIN lens” may be used interchangeably to refer to the lens of various embodiments. In various embodiments, the GRIN lens or the SuperGRIN lens may have a high numerical aperture (NA) (e.g. a Superhigh NA GRIN lens) and may be aberration-free such that light propagating through the lens may converge into a single point at a focus point.

In the context of various embodiments, a reference to a V-groove includes a reference to a U-groove. In the context of various embodiments, a reference to a groove includes a reference to a trench, a trough, a recess and the likes.

In the context of various embodiments, an optical arrangement includes at least one optical fiber. Each optical fiber may be arranged in a groove. In various embodiments, the optical fiber may be placed on a V-groove that is formed, for example by anisotropic wet etching, on a substrate. However, it should be appreciated that a U-groove or any groove with other cross-sectional configuration or shape may be formed and provided for placement of the optical fiber. For example, by using a combination of wet and dry etching techniques, various groove structures may be formed. In various embodiments, providing a U-groove may alleviate challenges due to thermal expansion differences between the fiber and the grooved substrate, which may cause movement of the fiber, as there may be a volume of space between the fiber positioned in the U-groove to the bottom of surface of the U-groove.

In order that the invention may be readily understood and put into practical effect, particular embodiments will now be described by way of examples and not limitations, and with reference to the figures. It should be appreciated that the methods of various embodiments may be CMOS compatible.

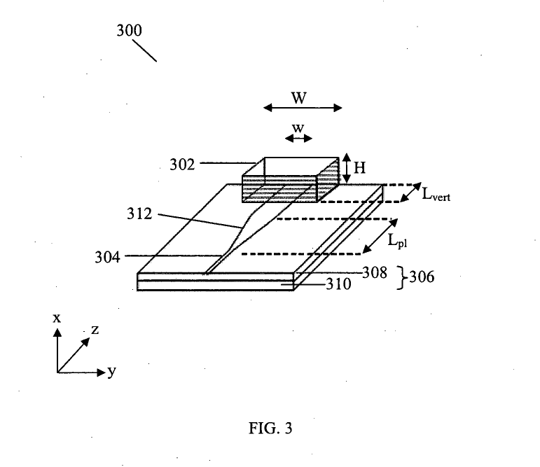

FIG. 3 shows a schematic diagram of an optical arrangement 300 with a SuperGRIN lens 302 integrated with a semiconductor waveguide (e.g. silicon (Si)) 304 on a photonic integrated circuit (PIC) 306, according to various embodiments. The optical arrangement 300 may be used for the optical beam transformation from a single mode fiber (not shown) to sub-micron optical waveguides, e.g. silicon (Si) waveguide 304. The optical beam may be transformed from a circular mode from the optical fiber having a diameter of about 9-10 μm, to an elliptical mode shape with sub-micron dimensions.

In various embodiments, the PIC 306 may include a cladding layer of buried oxide (e.g. SiO₂) 308 and a substrate (e.g. Si) 310. In various embodiments, various components may be present on the PIC 306, but are not shown in FIG. 3 for clarity purposes.

The SuperGRIN lens 302 may include a bi-material configuration with high refractive index contrast materials (Si/SiO₂) and may have a high numerical aperture (NA) (e.g. a SuperHigh NA GRIN lens), for example an NA of 3.2 or more (i.e. ≧3.2), such that the SuperGRIN lens 302 may focus light down to about a sub-0.5 μm spot size in the vertical direction (i.e. in the x-direction in FIG. 3) due to the use of high refractive index contrast materials (Si/SiO₂), in comparison to, for example, the SiO₂/TiO₂ combination. This may be achieved, for example, for a lens length Lᵥₑᵣₜ, of approximately 20 μm for coupling to a standard single mode fiber, e.g. SMF-28, and for a lens length Lᵥₑᵣₜ of approximately 11.6 μm for coupling to Nufern™ small-core single mode fiber having a core diameter of about 5 μm. Such a configuration occupies low Si area on the PIC chip 306.

In various embodiments, the horizontal mode transformation (i.e. in the y-direction in FIG. 3) is achieved by a lateral up-taper waveguide, as represented by 312, of the waveguide 304 on the buried cladding oxide layer 308. The vertical mode transformation (i.e. in the x-direction in FIG. 3) is achieved by the composite optical structure of the multilayer dual thin film materials of the SuperGRIN lens 302, forming an effective graded refractive index (GRIN) lens to provide focusing action in the vertical direction. In various embodiments, the SuperGRIN lens 302 has a thickness H, being the total thickness of the GRIN lens, and a width W. The waveguide 304 has a final termination width w, at the output facet, being about the size of the optical mode of the optical fiber (not shown).

The planar up-taper waveguide 312 expands the modal field of the Si-waveguide in the y-direction to approximately 5 μm and 10 μm, compatible with small-core (Nufern980™) and standard single mode optical fibers, respectively, as the modal field propagates towards the SuperGRIN lens 302. The y-directionally expanded field then expands in the x-direction as it propagates into the SuperGRIN lens 302. The SuperGRIN lens 302 consists of alternating layers of Si and SiO₂. In various embodiments, by varying the ratio of thicknesses of the Si and SiO₂ layers in the x-direction and as the film thicknesses are less than a quarter of optical wavelength in the medium, the propagating light-wave experiences an at least substantially parabolic effective refractive index profile of the SuperGRIN lens 302 in the x-direction. Such a refractive index profile enables an optical mode size transformation from an optical fiber to a sub-0.5 μm size.

In various embodiments, the optical arrangement 300 of FIG. 3 may be integrated with an optical fiber, which may be placed for example, on a V-groove, and which may be tied down or secured in the V-groove in order to provide suitable optical alignment and prevent any movement of the optical fiber which may cause misalignment.

FIG. 4A shows a cross-sectional view of an optical arrangement 400 with a SuperGRIN lens 402 formed on a waveguide 404, according to various embodiments. The SuperGRIN lens 402 has an asymmetric refractive index profile 406, which may be of an at least substantially parabolic profile or an at least substantially bell curve profile. As shown in FIG. 4A, the SuperGRIN lens 402 is formed asymmetrically on the waveguide 404, which may be a Si waveguide. The waveguide 404 is formed on an underlying buried oxide layer (e.g. a SiO₂ layer) 408 and on a substrate (e.g. Si) 410. The waveguide 404 may include an up-taper waveguide, as shown in the top view of FIG. 4A.

The optical arrangement 400 further includes integration of the SuperGRIN lens 402 to an optical fiber (e.g. a single mode fiber) 412 positioned on a V-groove 414 on the same optical platform. The optical fiber 412 includes a cladding portion 415 and a fiber core 416. The fiber core 416 is at least substantially aligned with the SuperGRIN lens 402 (e.g. the SuperGRIN lens 402 is arranged along a same axis as the fiber core 416) so as to allow coupling of light between the optical fiber 412 and the SuperGRIN lens 402, and also with the waveguide 404. For example, a light, as represented by the arrow 418a, with a certain spot size travelling in the waveguide 404 is expanded by the SuperGRIN lens 402 to a larger spot size. The light, as represented by the arrow 420a, with the expanded spot size is then coupled to the fiber 412 and propagates in the fiber core 416. Conversely in the opposite coupling direction, a light, as represented by the arrow 420b, with a certain spot size travelling in the fiber core 416 is coupled to the waveguide 404 after encountering the SuperGRIN lens 402. The SuperGRIN lens 402 focuses the light 420b to a light, as represented by the arrow 418b, with a smaller spot size which then propagates in the waveguide 404.

FIG. 4B shows a cross-sectional view of an optical arrangement 430 with a SuperGRIN lens 432 formed or deposited on an underlying buried oxide layer 434, according to various embodiments. The SuperGRIN lens 432 has an asymmetric refractive index profile 436, which may be of an at least substantially parabolic profile or an at least substantially bell curve profile. As shown in FIG. 4B, the SuperGRIN lens 432 is formed asymmetrically on the buried oxide layer (e.g. a SiO₂ layer) 434, and with a side facet at least partially in contact with a waveguide (e.g. Si) 438 (e.g. the SuperGRIN lens 432 is butt-coupled to the waveguide 438). The waveguide 438 is formed on the buried oxide layer 434 and on a substrate (e.g. Si) 440. The waveguide 438 may have a substantially uniform width, as shown in the top view of FIG. 4B.

The optical arrangement 430 further includes integration of the SuperGRIN lens 432 to an optical fiber (e.g. a single mode fiber) 442 positioned on a V-groove 444 on the same optical platform. The optical fiber 442 includes a cladding portion 445 and a fiber core 446. The fiber core 446 is at least substantially aligned with the SuperGRIN lens 432 (e.g. the SuperGRIN lens 432 is arranged along a same axis as the fiber core 446) so as to allow coupling of light between the optical fiber 442 and the SuperGRIN lens 432, and also with the waveguide 438. For example, a light, as represented by the arrow 448a, with a certain spot size travelling in the waveguide 438 is expanded by the SuperGRIN lens 432 to a larger spot size. The light, as represented by the arrow 450a, with the expanded spot size is then coupled to the fiber 442 and propagates in the fiber core 446. Conversely in the opposite coupling direction, a light, as represented by the arrow 450b, with a certain spot size travelling in the fiber core 446 is coupled to the waveguide 438 after encountering the SuperGRIN lens 432. The SuperGRIN lens 432 focuses the light 450b to a light, as represented by the arrow 448b, with a smaller spot size which then propagates in the waveguide 438.

Various embodiments may provide a method of designing or determining the composite layer thicknesses of the SuperGRIN lens so as to provide one or more of the following: maximizing the coupling efficiency between the single mode fiber and the sub-micron optical waveguide; minimizing the layer interface scattering among the layers of the lens; minimizing the optical input facet scattering; minimizing lens aberration; and minimizing the overall focal length of the lens such that as small chip area as possible is required. In various embodiments, the multiple layers in the vertical SuperGRIN lens may be deposited by, for example but not limited to, Ion-Assisted-Deposition (IAD) at low cost and with low optical loss.

In various embodiments, the multi-layer SuperGRIN lens structure may be deposited on a lateral up-taper semiconductor waveguide (e.g. the embodiment of FIG. 3), for performing transformation of optical modes in both the vertical and lateral directions from a single mode fiber to a sub-micron optical waveguide or vice versa. The asymmetrical vertical SuperGRIN lens structure, having an assymmetrical refractive index profile, in combination with the lateral up taper waveguide, may have a cascaded or concurrent geometry to transform the optical beam mode in both the vertical and lateral directions, either sequentially or simultaneously.

In various embodiments, the SuperGRIN lens may be arranged on a silicon (Si)-waveguide, for example the SuperGRIN lens may be deposited directly on the Si-waveguide, as shown in the embodiment of FIG. 4A. In various embodiments, the underlying Si-waveguide may be etched away, and the SuperGRIN lens stack is placed or deposited on the underlying dielectric cladding (e.g. buried oxide layer), as shown in the embodiment of FIG. 4B.

Various embodiments may provide one or more methods of fabricating optical module structures or optical arrangements including a multi-layer SuperGRIN lens integrated on a semiconductor photonic/optical waveguide (e.g. a silicon photonic waveguide or a silicon photonic wire waveguide), for example as shown in the embodiments of FIGS. 3 and 4A. The method may include one or more of the following: the formation of a sub-micron sized Si-photonic wire waveguide on an SOI substrate; the deposition of a passivation dielectric layer (e.g. preferably a silicon dioxide (SiO₂) layer); the deposition of an etch stop layer (e.g. a metal layer); opening or removal of the dielectric layer at a region for fabrication of the SuperGRIN lens; deposition of the SuperGRIN lens stack (e.g. including layers of silicon (Si) and silicon dioxide (SiO₂)); and deep reactive ion etching (DRIE) of the SuperGRIN lens stack, ending at the etch stop layer. In various embodiments, a metal etch stop layer may be provided to prevent excessively aggressive etching into the embedded Si-waveguide during the etching of the SuperGRIN lens stack. It should be appreciated that the method or methods may include one or more or all of these processes. Furthermore, it should be appreciated that the method or methods are not limited to these processes and may include other additional processes and/or alternative processes.

In various embodiments, the DRIE process may be carried out using inductive-coupled plasma reactive ion etching (ICP/RIE), using etchant gases with at least substantially equal etch rates for Si and SiO₂, so as to maintain minimal differential etch rates of the layers of Si and SiO₂, in order to ensure smoothly etched input and output facets of the SuperGRIN lens.

Various embodiments may further provide one or more methods of fabricating an optical arrangement including a sub-micron sized photonic wire semiconductor (e.g. Si) optical waveguide having a lateral up-taper configuration, an asymmetrical multi-layer SuperGRIN lens integrated on the optical waveguide and an integrated V-groove for passive alignment with a single mode fiber. It should be appreciated that one or more optical waveguides may be fabricated, one or more SuperGRIN lens may be fabricated and one or more V-grooves may be integrated in the optical arrangement. The fabrication methods are compatible with the Complementary Metal-Oxide Semiconductor Field Effect Transistor (CMOSFET) fabrication environment, so that the SuperGRIN lens may be part of a chip integrated with both CMOS electronics and photonics. The SuperGRIN lens(es) functions as an interface or coupler to the optical fiber or an array of fibers that may be positioned on the one or more V-grooves. In various embodiments, the process flow of such method or methods may be used for an electronic-photonic module comprising one or more SuperGRIN lenses on a Si-platform substrate with one or more pre-fabricated V-grooves. In the optical arrangement, the photonic integrated circuit (PIC) with an integrated SuperGRIN lens is diced from the main wafer. Regularly spaced bond pads on the periphery of the PIC die are electrically connected to a bottom printed-circuit-board (PCB) of the module by wire-bonding. Optical fiber is placed on the V-groove, passively aligned to the SuperGRIN lens coupler. A separately prepared V-groove substrate is picked, placed and pressed upside down on the single mode fiber. The optical fiber may be immobilized in the V-groove by flowing in a curable resin adhesive or epoxy into the V-groove. The epoxy used may be any material that has an at least substantially similar refractive index to the refractive index of the cladding of the optical fiber.

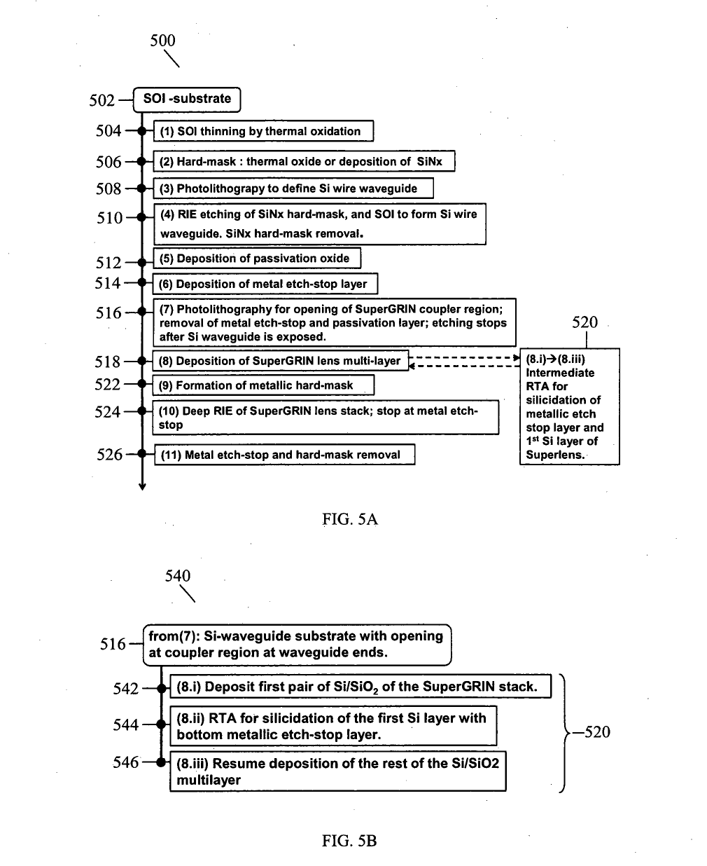

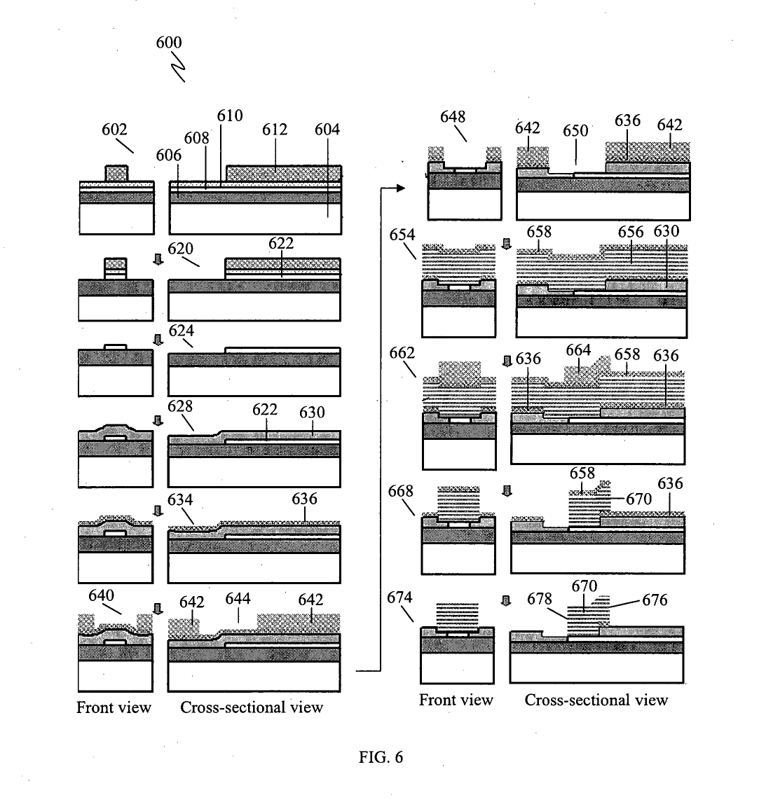

The process of fabricating a SuperGRIN lens on a Si-photonic waveguide, will now be described with reference to FIGS. 5A, 5B and 6.

FIG. 5A shows a process flow 500 of fabricating a SuperGRIN lens integrated on a silicon photonic waveguide, FIG. 5B shows a process flow 540 of strengthening an interface between a SuperGRIN lens and a metallic etch stop layer, while FIG. 6 shows a process 600 of fabricating a SuperGRIN lens on a Si-photonic waveguide, according to various embodiments. The process 600 of FIG. 6 relates to the embodiment where a layer of silicon nitride (SiNₓ) is used as a hard-mask.

At 502, a silicon-on-insulator (SOI) substrate is provided. The SOI substrate may be on a silicon wafer.

At 504, thinning of the SOI substrate is performed by thermal oxidation until the necessary thickness of silicon (Si) is obtained for the fabrication of the Si-photonic waveguide (e.g. a Si-photonic wire waveguide). The layer of thermal oxide formed may or may not be removed.

At 506, the oxide layer formed at 504 may be used as a hard-mask for the formation of the Si-photonic waveguide. Optionally, a layer of silicon nitride (SiNₓ) with a thickness of about 200 nm may be deposited by low-pressure chemical vapor deposition (LPCVD) on the oxide layer to act as a hard-mask.

At 508, photolithography or e-beam lithography is performed to define the configuration or structure of the Si-photonic waveguide. As an example and not limitation, the lithography process may be carried out to define a waveguide including an up-taper geometry or a waveguide with a substantially uniform width. As shown in FIG. 6, a structure 602 is obtained after the process at 508. The structure 602 includes a silicon substrate 604, a BOX (e.g. an insulating layer) 606, an SOI 608, a layer of silicon nitride (SiNₓ) 610 acting as a hard-mask and a photoresist 612. The photoresist 612 is used to define a geometry or configuration for transfer to the SOI 608 to fabricate a waveguide.

At 510, etching is performed to fabricate the Si-photonic waveguide. In embodiments where the thermal oxide layer formed at 504 is used as the hard mask, reactive ion etching (RIE) or inductive-coupled plasma reactive ion etching (ICP/RIE) may be used to etch the thermal oxide layer and the SOI 608, until the buried oxide (BOX) 606 of the SOI substrate. In embodiments where a layer of SiNₓ 610 is formed at 506 as the hard mask, RIE may be used to etch the SiNₓ 610 and the SOI 608, until the buried oxide (BOX) 606. As shown in FIG. 6, a structure 620 including a waveguide 622 is obtained.

Subsequently at 510, the photoresist 612 is removed and the layer of SiNₓ 610 is removed by dipping the wafer in boiling phosphoric acid. As shown in FIG. 6, a structure 624 is obtained.

At 512, a layer of passivation oxide (e.g. a layer of SiO₂) may be deposited by plasma-enhanced chemical vapor deposition (PECVD) on the Si-photonic waveguide. As shown in FIG. 6, a structure 628 is obtained. The structure 628 includes a layer of passivation oxide 630 covering the waveguide 622. In various embodiments, the layer of passivation oxide 630 may have a thickness in a range of between about 0.4 μm to about 2 μm, e.g. a range of between about 0.4 μm to about 1.2 μm, a range of between about 0.4 μm to about 0.8 μm or a range of between about 0.8 μm to about 2 μm.

At 514, a metal etch stop layer may be deposited on the passivation layer 630 for use during the subsequent etching of a SuperGRIN lens stack that is deposited on the metal etch stop layer to form a SuperGRIN lens. In various embodiments, the metal etch stop layer may include but is not limited to aluminium (Al), nickel/titanium (Ni/Ti), chromium/titanium (Cr/Ti) or copper (Cu). As shown in FIG. 6, a structure 634 is obtained. The structure 634 includes a metal etch stop layer 636 deposited on the layer of passivation oxide 630.

At 516, photolithography is performed to define an opening for a coupler region where a SuperGRIN lens stack may also be deposited into in a subsequent process. As shown in FIG. 6, a structure 640 is obtained. The structure 640 includes a photoresist 642 with an opening 644 corresponding to a coupler region.

Subsequently at 516, RIE is then performed to etch away the metal etch stop layer 636 and the layer of passivation oxide 630 in the coupler region to expose the Si-photonic waveguide. As shown in FIG. 6, a structure 648 is obtained. The structure 648 includes the coupler region 650.

Alternatively at 516, the exposed Si-photonic waveguide may also be etched away, stopping at the layer of buried oxide (BOX) 606 of the SOI substrate as the BOX 606 is preserved and not etched.

Subsequently at 516, the photoresist 642 is removed.

At 518, a SuperGRIN lens multi-layer stack is deposited. In various embodiments, the process that may be used to deposit the alternating dual layer materials (e.g. Si and SiO₂) of the SuperGRIN lens include but is not limited to plasma-enhanced chemical vapor deposition (PECVD), sputtering, thermal evaporation, ebeam evaporation, or ion- assisted deposition (IAD).

In various embodiments, in between the processes at 516 and 518, prior to deposition of a SuperGRIN lens stack, the wafer may be dipped in dilute hydrofluoric scid (HF) to undercut the layer of passivation oxide 630 in order to create a discontinuity in the SuperGRIN lens stack at the edge of the layer of passivation oxide 630. This process sequence results in a SuperGRIN lens structure overlaid on a step on the layer of passivation oxide 630.

At 520, an optional intermediate process involving rapid thermal annealing (RTA) of the wafer after the first amorphous-Si (a-Si or α-Si) layer of the multilayer stack is deposited may be carried out in order to prevent the SuperGRIN lens multi-layer stack from peeling away from the bottom metal etch stop layer. In embodiments where the SuperGRIN lens stack adheres well to the bottom metal etch stop layer, the process at 520 may not be necessary.

The intermediate process at 520 is described in further details with reference to FIG. 5B. At 542, after the processes performed at 516, a first pair of Si/SiO₂ of the SuperGRIN lens is deposited. At 544, the sample wafer goes through a rapid thermal annealing (RTA) process for silicidation of the first a-Si layer of the SuperGRIN lens and the bottom metallic etch stop layer. In embodiments where the metal etch stop layer includes a top layer of titanium (Ti), the RTA process, for example carried out at about 500° C.-600° C., may cause the formation of titanium silicide, which facilitates strengthening of the interface between the SuperGRIN lens and the metallic etch stop layer (e.g. the interface between the first amorphous silicon (a-Si) layer of the SuperGRIN lens and the Ti-etch stop layer). The titanium silicide formed may be a thin layer. At 546, after the RTA process, the process of depositing multilayer Si/SiO₂ continues until the complete SuperGRIN lens stack is deposited.

Referring now to FIG. 5A, at 522, a metal hard-mask is deposited. In various embodiments, the metal hard-mask may include but is not limited to nickel (Ni), nickel/titanium (Ni/Ti), chromium/titanium (Cr/Ti) or aluminium (Al). In various embodiments, the hard-mask of Ni/Ti or Cr/Ti may be deposited by but not limited to sputtering, electron-beam evaporation, thermal evaporation, or Filtered Cathodic Vacuum Arc technology (FCVA), which are classified as physical vapor deposition (PVD) processes. FCVA advantageously enables deposition with small grain sizes of approximately 5 nm, which are suitable for smooth side-wall (e.g. input facet) RIE.

In various embodiments, a Ni/Ti hard-mask is used. In one embodiment, the hard-mask is deposited by physical vapor deposition (PVD). Ti, followed by Ni, may be blanket deposited. Ti functions as an adhesive layer to adhere Ni to the preceding substrate, for example a SuperGRIN lens stack. Subsequently, photolithography using a positive resist may be performed to define a SuperGRIN lens area. The Ni/Ti metal hard-mask may be dry etched by argon/chlorine (Ar/Cl₂) reactive ion beam etching (RIBE) to transfer the SuperGRIN lens pattern onto the RIBE-Ni hard-mask.

Alternatively, photolithography may be performed using a negative resist (e.g. SU-8 or other negative resist) to define a SuperGRIN lens area. The photolithography process creates an opening. A thin layer of chromium/gold (Cr/Au) is deposited into the opening of the negative resist, as a seed layer. Ni is then electroplated into the opening of the negative resist. Vertical side walls of the plated Ni hard-mask may be achieved by making vertical wall profiles of the negative resist and electroplating Ni to conform to the resist wall profiles.

As shown in FIG. 6, a structure 654 is obtained. The structure 654 includes a SuperGRIN lens multi-layer stack 656 and a metal hard-mask 658 that is deposited, for example by physical vapor deposition (PVD). The SuperGRIN lens multi-layer stack 656 includes alternating layers of Si and SiO₂. In various embodiments, the SuperGRIN lens stack 656 has a thickness in a range of between about 10 μm to about 12 μm or between about 5 μm to about 7 μm so that the SuperGRIN lens fabricated from the SuperGRIN lens stack 656 may be configured for coupling respectively to a SMF-28 standard fiber or a Nufern small-core single mode fiber.

At 524, photolithography may be performed to define a SuperGRIN lens area. As shown in FIG. 6, a structure 662 is obtained. The structure 662 includes a photoresist 664.

Subsequently at 524, the SuperGRIN multi-layer stack 656 may be etched to fabricate a SuperGRIN lens with vertical side walls using photoresist 664 and also the metal hard-mask 658 deposited at 522, by ICP-RIE using etchant gases with at least substantially equal etch rates of silicon and silicon dioxide so as to maintain minimal differential etch rates of the layers of Si and SiO₂, in order to ensure smoothly etched input and output facets of the SuperGRIN lens. The etchant gases used may include but is not limited to SF₆, CHF₃, C₄F₈ or CF₄, with addition of Ar or O₂ to provide vertical etched wall angle and input facet smoothness. In various embodiments, the side-wall roughness may be approximately 20 nm to approximately 50 nm. In the context of various embodiments, a combination of C₄F₈/O₂ or C₄F₈/SF₆ may be used for etching selectivity of 1:1 during the deep ICP-RIE dry etching of Si/SiO₂ to form vertical side walls.

As shown in FIG. 6, a structure 668 is obtained. The structure 668 includes a SuperGRIN lens 670. The SuperGRIN lens 670 includes an input facet 676 and an output facet 678.

At 526, the metal etch stop layer 636 and the hard-mask 658 are removed by dry plasma etching or wet etching. As shown in FIG. 6, a structure 674 is obtained.

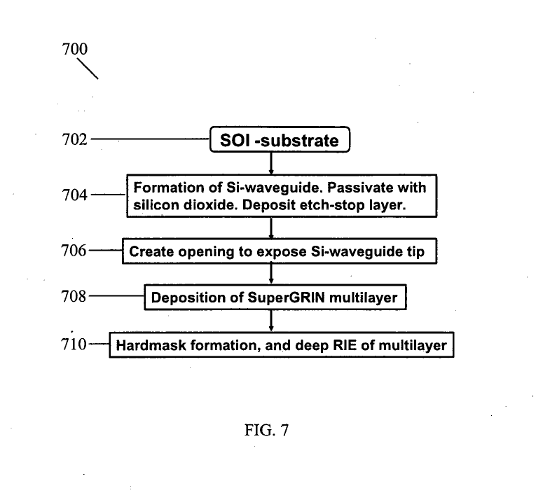

It should be appreciated that as other methods may be used to fabricate a Si-waveguide on an SOI substrate, FIG. 7 shows a generalized process flow 700 of fabricating a SuperGRIN lens on a Si-waveguide, according to various embodiments.

At 702, a silicon-on-insulator (SOI) substrate is provided. The SOI substrate may be on a silicon wafer.

At 704, a Si-waveguide is formed on the SOI substrate. A passivation layer (e.g. a layer of SiO₂) may be deposited, and subsequently a metal etch stop layer may be deposited.

At 706, an opening may be created at the tip of the Si-waveguide to expose the Si-waveguide. This process defines the input facet placement for a SuperGRIN lens.

At 708, a SuperGRIN lens multi-layer stack is blanket deposited over the SOI substrate.

At 710, a lithography process for hard-mask formation is performed, followed by DRIE of the SuperGRIN lens multi-layer stack to define the placement of the output facet of the SuperGRIN lens. With the input and output facets placement defined, the length of the GRIN lens is also defined.

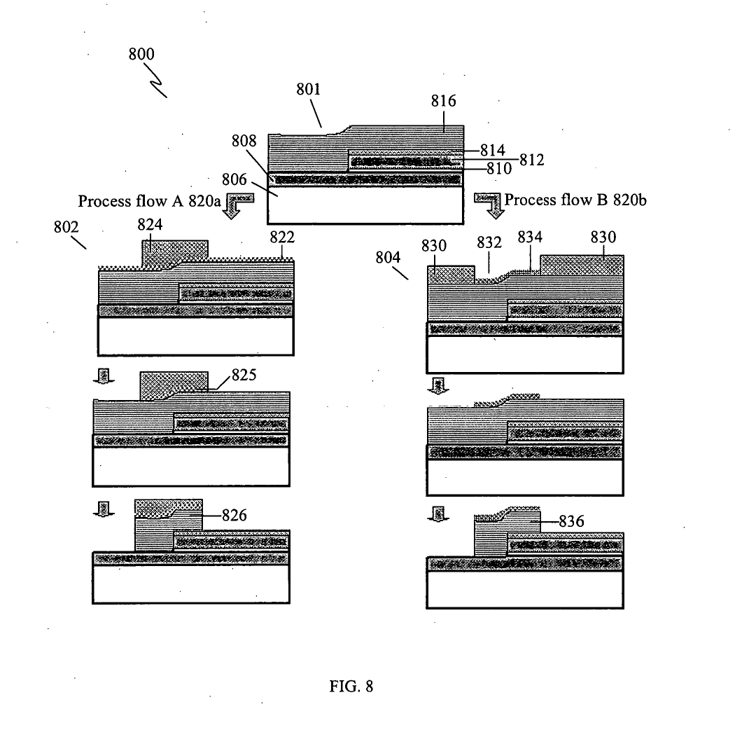

FIG. 8 shows a process 800 of forming a metallic hard-mask, according to the embodiment of FIG. 5A. FIG. 8 shows a structure 801 after the process at 518 of FIG. 5A. The structure 801 includes a silicon substrate 806, a BOX 808, an SOI 810, a passivation oxide layer 812, a metal etch stop layer 814 and a SuperGRIN lens stack 816. The SOI 810 includes a silicon waveguide.

Subsequently, a hard-mask (e.g. Ni or Ni/Ti) may be formed on the structure 801, by physical vapor deposition (PVD) based on process flow A 820a or by electroplating based on process flow B 820b, corresponding to the embodiment at 522 of FIG. 5A.

Following process flow A 820a, a metal (e.g. Ni) hard-mask 822 is deposited via PVD on the SuperGRIN lens stack 816 and a photolithography process using a positive photoresist 824 is carried out to define a SuperGRIN lens area (i.e. an area where the SuperGRIN lens is positioned). Subsequently, processes to transfer the pattern of the positive photoresist 824 onto the hard-mask 822, for example by RIE to form patterned hard-mask 825 with vertical side walls, and etching of the SuperGRIN lens stack 816 to form a SuperGRIN lens 826 and other processes may be performed.

Following process flow B 820b, a photolithography process using a negative photoresist 830 is carried out to create an opening 832 to define a SuperGRIN lens area (i.e. an area where the SuperGRIN lens is positioned). A metal (e.g. Ni) hard-mask 834 is then deposited via electroplating in the opening 832 on the SuperGRIN lens stack 816. Subsequently, etching of the SuperGRIN lens stack 816 to form a SuperGRIN lens 836 and other processes may be performed.

In the context of various embodiments, electroplating may be performed in DC mode and/or reverse-pulse mode to form vertical Ni side walls and smooth surface morphology.

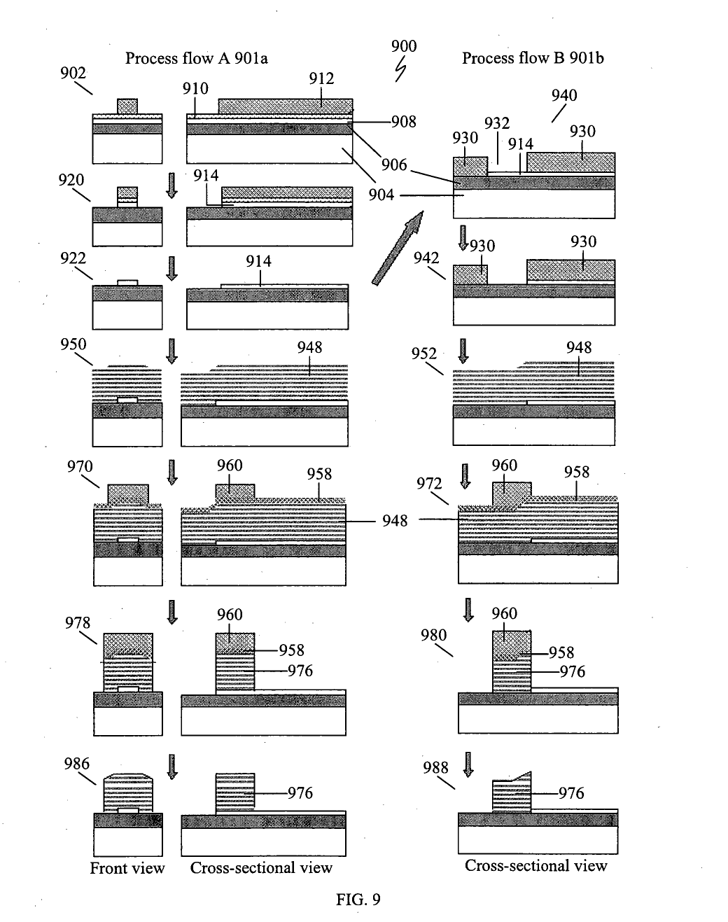

FIG. 9 shows a process 900 for fabricating a SuperGRIN lens on a Si-photonic waveguide, according to various embodiments. The process 900 is now described with reference to FIG. 5A, as an example and not limitations. Following process flow A 901a results in the fabrication of a SuperGRIN lens on a waveguide, similar to the embodiment shown in FIG. 4A, while following process flow B 901b results in the fabrication of a SuperGRIN lens on a buried oxide layer, similar to the embodiment shown in FIG. 4B.

FIG. 9 shows a structure 902 after the process at 508 of FIG. 5A. The structure 902 includes a silicon substrate 904, a BOX 906, an SOI 908, a layer of silicon nitride (SiNₓ) 910 acting as a hard-mask and a photoresist 912. The photoresist 912 is used to define a geometry or configuration for transfer to the SOI 908 to fabricate a waveguide.

Subsequently, following the process at 510 of FIG. 5A, etching of the layer of silicon nitride (SiNₓ) 910 and the SOI 908 is performed to fabricate the Si-photonic waveguide 914. A structure 920 is obtained.

Subsequently, the SiNₓ layer 910 and the photoresist 912 may be removed and the structure 922 is obtained.

Following the process at 516 of FIG. 5A, etching may be performed to expose the Si-photonic waveguide, as shown by the structure 922.

Subsequently, the structure 922 may be processed based on the process flow A 901a to fabricate a SuperGRIN lens on the waveguide 914, or the structure 922 may be processed based on the process flow B 901b to fabricate a SuperGRIN lens on the BOX 906.

As shown for the process flow B 901b, using the structure 922, a photolithography process using a photoresist 930 is carried out to create an opening 932, as shown by the structure 940. An etching process is then carried out to etch away the waveguide 914 exposed through the opening 932 and the structure 942 is obtained.

Following the process at 518 of FIG. 5A, a SuperGRIN lens multi-layer stack 948 is deposited, either on the structure 922, resulting in the structure 950 based on the process flow A 901a or after removal of the photoresist 930 of the structure 942, resulting in the structure 958 based on the process flow B 901b.

Following the process at 522 of FIG. 5A, a metal hard-mask 958 is deposited, for example by physical vapor deposition (PVD). Subsequently, photolithography using a photoresist 960 is performed to define a SuperGRIN lens area, as shown by the structure 970 based on the process flow A 901a or the structure 972 based on the process flow B 901b.

Following the process at 524 of FIG. 5A, the SuperGRIN lens multi-layer stack 948 is etched to fabricate a SuperGRIN lens 976, as shown by the structure 978 based on the process flow A 901a or the structure 980 based on the process flow B 901b.

Following the process at 526 of FIG. 5A, the metal hard-mask 958 and the photoresist 960 are removed, as shown by the structure 986 based on the process flow A 901a or the structure 988 based on the process flow B 901b.

It should be appreciated that the embodiment of FIG. 9 does not include the processes at 512 and 514 of FIG. 5A, i.e. no intermediate embedded layer of passivation oxide and layer of metallic etch stop is formed.

FIG. 10 shows a cross-sectional view of an optical arrangement 1000 incorporating a passive alignment scheme for alignment of a single mode optical fiber 1002 to a SuperGRIN lens 1004 on a PIC integration platform 1006, according to various embodiments. The SuperGRIN lens 1004 includes a multilayer structure of Si/SiO₂. The PIC integration platform (or PIC chip) 1006 is based on an SOI substrate, including a Si substrate 1008 and a buried oxide (BOX) 1009.

The optical arrangement 1000 includes a V-groove 1010 formed as part of the integration platform 1006, where the fiber 1002 is placed on or in the V-groove 1010. The configuration of having an integrated V-groove 1010 for passive alignment of the fiber 1002, an asymmetrical SuperGRIN lens 1004 and a Si photonic waveguide (e.g. a nano-waveguide) 1012 fabricated on the integration platform 1006, may achieve sub-micron alignment tolerance. In various embodiments, the V-groove 1010 may be a U-groove.

In various embodiments, the required alignment tolerances of such a configuration may be achieved as described below.

In various embodiments, the V-groove 1010 is anisotropically etched on the Si substrate 1008 of the integration platform 1006 to provide a fiber placement accuracy of approximately ±(0.5 μm to 1 μm), when the optical fiber 1002 is at least substantially firmly pressed down or secured on the V-groove 1010.

The SuperGRIN lens 1004 is deposited directly on the integration platform 1006. The Si-waveguide 1012 is fabricated out of the SOI. As shown in FIG. 10, SuperGRIN lens 1004 is configured to function as a coupler between the fiber 1002 and the Si-waveguide 1012. The coupling efficiency between the single-mode optical fiber 1002 and the SuperGRIN lens 1004 depends on the accuracy of the alignment of the centre of the fiber core 1014 and the centre of the optical output beam from the SuperGRIN lens 1004. The location on the output facet 1016 of the SuperGRIN lens 1004 where the optical intensity is at the peak or maximum may be located at a half-way point from the bottom of the stack of the SuperGRIN lens 1004 to the top of the stack of the SuperGRIN lens 1004. The accuracy of the location of the optical intensity peak is, therefore, related to the accuracy of the half-way point or mid-point of the SuperGRIN lens 1004. The alignment accuracy of the SuperGRIN lens 1004 is dependent on the thickness accuracy of the individual layer in the multi-layer SuperGRIN lens 1004. As the thickness accuracy of each individual layer is in the order of a few nm, and that the number of layers is between about 70 to about 80, the accuracy of the beam centre at the output of the SuperGRIN lens is sub-0.5 micron, e.g. about 0.2 μm to about 0.4 μm.

In various embodiments, the distance X1 from the bottom surface of the buried-oxide 1009 to the center of the SuperGRIN lens 1004 has an accuracy of sub-0.5 micron. The distance X2 from the bottom surface of the buried-oxide 1009 to the bottom of the V-groove 1010 is dependent on the width of the V-groove 1010, where the width has an accuracy of about ±0.5 μm. As a result, the accuracy of the surfaces of the V-groove 1010 is ±0.5 μm.

Furthermore, the accuracy of the location of the centre of the fiber core 1014 is related to the accuracy of the planes positions of the V-groove 1010. Where the planes are correctly etched along the [111] crystal plane, the accuracy of the centre of the fiber core 1014 due to the planes of the V-groove 1010, is approximately ±(0.5 μm to 1 μm). In addition, as the accuracy of the radius of a good quality optical fiber is approximately ±(0.5 μm to 1 μm), the accuracy of the vertical placement of the center of the optical fiber core is approximately ±(0.5 μm to 1 μm). Therefore, based on FIG. 10, the vertical alignment accuracy of the centre of the fiber core 1014 and the centre of the SuperGRIN lens 1004 is approximately ≦1 μm. FIG. 10B shows a plot 1020 illustrating additional coupling loss against vertical misalignment between the fiber core 1014 and the SuperGRIN lens 1004, based on the embodiment of FIG. 10A. As shown in FIG. 10B, the additional coupling loss of fiber-core to SuperGRIN lens is approximately 1 dB or less for a vertical misalignment of ≦1 μm, which may be considered low and manageable for fiber-pigtailed active optoelectronic devices.

In addition, as the accuracy of the surfaces of the V-groove 1010 is approximately ±0.5 μm, the lateral accuracy of the center of the fiber core 1014 is approximately ±(0.5 μm to 1 μm). In various embodiments, the lateral placement accuracy of the output beam may be determined by the lateral placement of the Si-waveguide 1012. The lateral placement accuracy of the Si-waveguide 1012 is substantially zero as it is dependent on the photolithography and vertical side-wall etching processes.

Various embodiments may provide integration of a SuperGRIN lens on a photonic waveguide to a V-groove or a U-groove. The V-groove may be used for placement of an optical fiber for achieving passive alignment with the SuperGRIN lens.

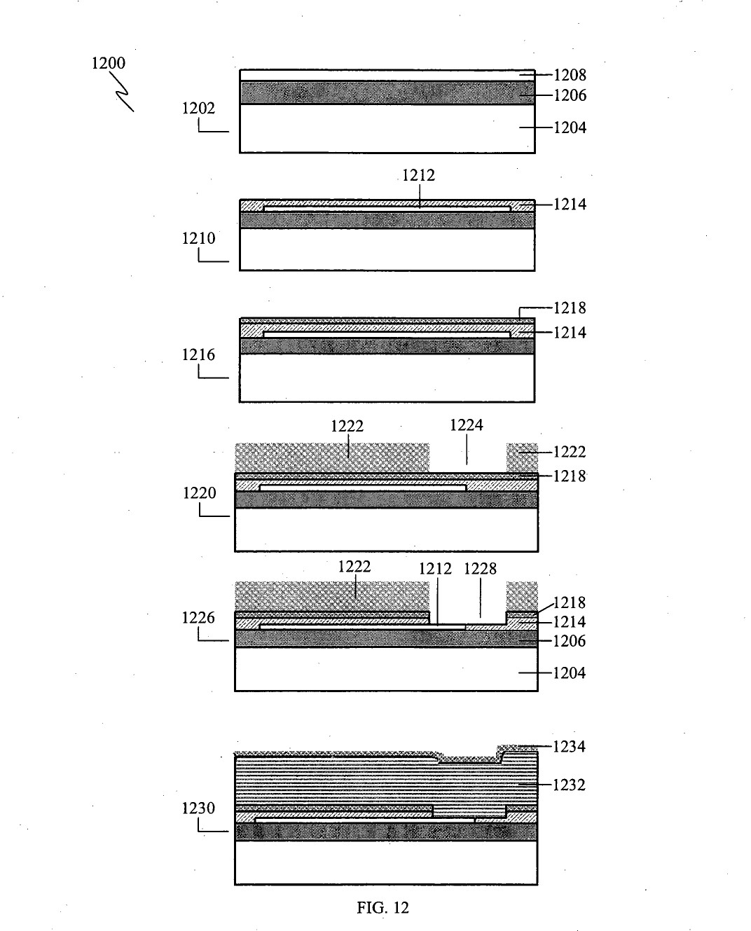

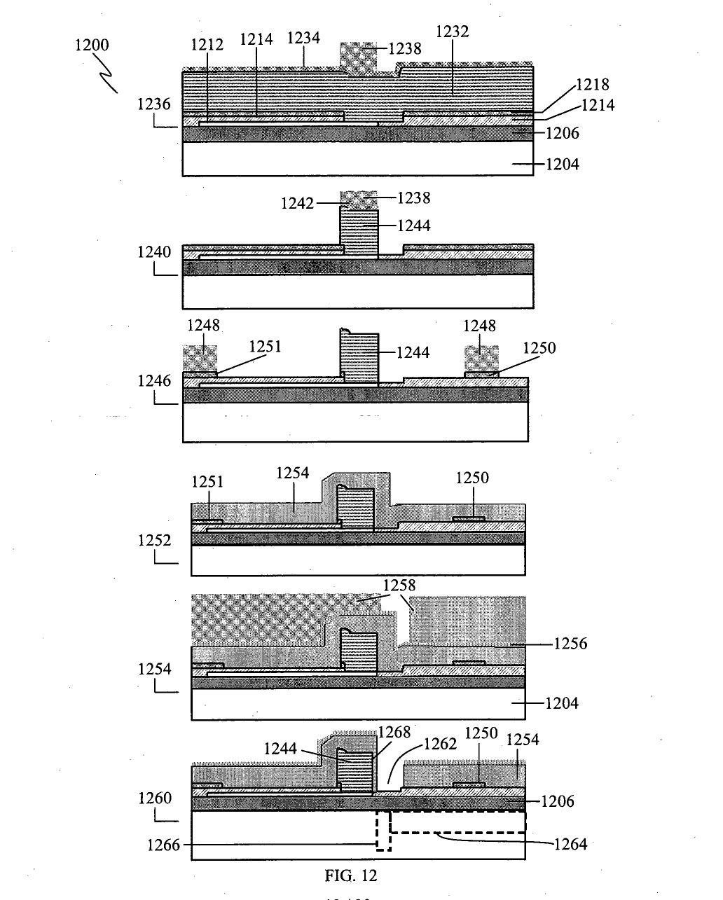

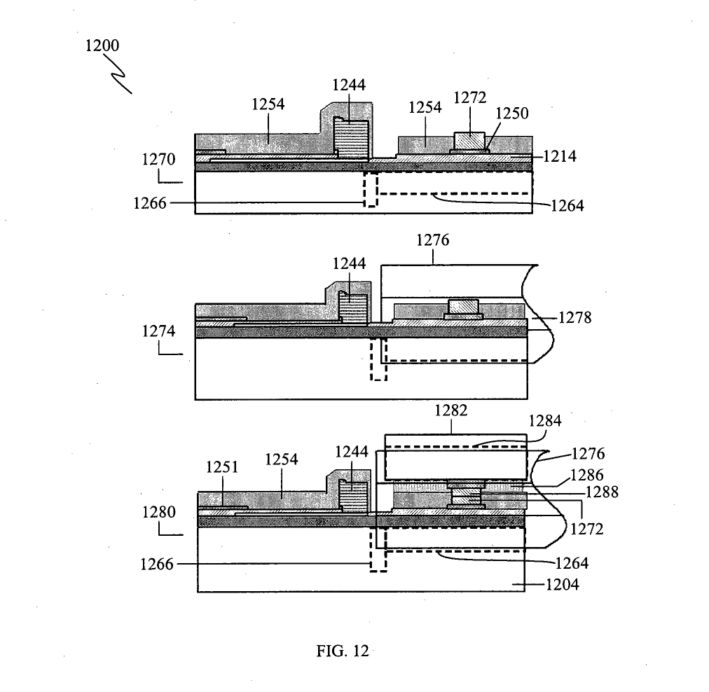

The process of fabricating a SuperGRIN lens on a Si-photonic waveguide, integrated with a V-groove, will now be described with reference to FIGS. 11 and 12. FIG. 11 shows a process flow 1100 of integrating a SuperGRIN lens on a photonic waveguide to a V-groove, while FIG. 12 shows a process 1200 of fabricating a SuperGRIN lens on a photonic waveguide integrated with a V-groove, according to various embodiments.

At 1102, a [110] oriented Si substrate (or wafer) as support substrate is provided. The Si substrate may be used for the formation of a V-groove for placement of a single mode fiber in a later process. Thermal oxidation is then performed on the Si substrate to form a buried oxide (BOX) which acts as a cladding for a Si-photonic waveguide (e.g. a buried channel) that is to be formed in a later process. Silicon-on-insulator (SOI) layer is then formed on the BOX together on the Si-[110] handle substrate. The SOI layer may be formed by various conventional methods, for example the ‘Smart-cut’ method. As shown in FIG. 12, a structure 1202 is obtained. The structure 1202 includes a Si[110] substrate 1204, a BOX 1206 and an SOI layer 1208.

In various embodiments, the thickness of the BOX 1206 is at least more than 700 nm (i.e. ≧700 nm), to ensure minimum optical power leakage into the Si substrate 1204 for both the transverse electric (TE) and transverse magnetic (TM) modes propagating in the Si-waveguide to be formed in the SOI layer 1208. The thickness of the BOX 1206 nevertheless should be sufficiently thin to satisfy the requirement of SOI-based electronics devices which may be integrated on the same platform, where a thick BOX 1206 may not be used.

In alternative embodiments, at 1102, a standard SOI wafer with a [100]-aligned Si substrate, with the straight edges aligned along [110], may be used.

At 1104, front-end-of-line processes involving the formation of a Si-photonic waveguide, a layer of passivation oxide or dielectric (e.g. a layer of pre-metal dielectric), and a diffusion layer of electronics and photonics devices, may be performed. Processes performed include photolithography and etching, for example to define and form the Si-photonic waveguide, ion-implantation, annealing, and pre-metal dielectric deposition, such as plasma-enhanced chemical vapor deposition (PECVD). The diffusion layer may be a semiconductor layer, including silicon and/or III-V materials.

As shown in FIG. 12, a structure 1210 is obtained. The structure 1210 includes a fabricated Si-photonic waveguide 1212 and a layer of passivation oxide (e.g. SiO₂) 1214 deposited over the Si-photonic waveguide 1212. While not shown in FIG. 12, the structure 1210 may include other structures, such as a diffusion layer.

In various embodiments, the thickness of the layer of passivation oxide 1214 is between about 0.4 μm to about 2 μm, for optical isolation, and should be sufficiently thin so as not to distort the layers of the SuperGRIN lens stack that are to be deposited in a later process.

At 1106, back-end-of-line processes involving the formation of contact-via or vias and a metal etch stop layer, may be performed. As shown in FIG. 12, a structure 1216 is obtained. The structure 1216 includes a metal etch stop layer 1218. While not shown in FIG. 12, the structure 1216 may include contact-vias.

In various embodiments, the contact-vias may be formed by aluminium (Al)-deposition, or formed by a tungsten (W) plug process, or formed by a copper (Cu)-via process. In one embodiment, Al deposition into the via is performed as the aluminium material is widely available in the fabrication foundry. In another embodiment, the W-via process may be performed as it allows a high via aspect ratio.

In various embodiments, the metal etch stop layer 1218 may include but is not limited to aluminium (Al), nickel/titanium (Ni/Ti), chromium/titanium (Cr/Ti) or copper (Cu). The metal etch stop layer 1218 should be sufficiently thin so as not to distort the layers of the SuperGRIN lens stack that are to be deposited in a later process.

At 1108, photolithography is performed to define an opening for a coupler region where a SuperGrin lens stack may also be deposited into in a subsequent process. As shown in FIG. 12, a structure 1220 is obtained. The structure 1220 includes a photoresist 1222 with an opening 1224 corresponding to a coupler region.

Subsequently at 1108, RIE is performed to etch away the metal etch stop layer 1218 and the layer of passivation oxide 1214 in the coupler region to expose the Si-photonic waveguide 1212. As shown in FIG. 12, a structure 1226 is obtained. The structure 1228 includes a coupler region 1228. This may result in a configuration substantially similar to the embodiment of FIG. 4A.

Alternatively at 1108, the exposed Si-photonic waveguide 1212 may also be etched away, for example by dry etching, stopping at the buried oxide (BOX) 1206. This may result in a configuration substantially similar to the embodiment of FIG. 4B.

Subsequently at 1108, the photoresist 1222 is removed.

In various embodiments, the coupler opening region 1228 may overlap with a terminating end of the Si-photonic waveguide 1212 with extra spatial protrusion into the waste edge of the die, similar to the structure 1226. Such a configuration may minimize layer distortion of the multi-layer SuperGRIN lens stack that is to be deposited in a later process. In the context of various embodiments, the term “waste edge of the die” may mean a region of the die from a tip of a Si-waveguide to the edge of the die where dicing cut is made.

In various embodiments, an additional isotopic etch step may be performed to create a dielectric undercut at the edge to the SuperGRIN lens coupler region 1228 to facilitate discontinuity in the subsequent SuperGRIN lens layers formed during its deposition.

At 1110, a multi-layer SuperGRIN lens stack is deposited. In various embodiments, the process that may be used to deposit the alternating dual layer materials (e.g. amorphous Si and SiO₂) of the SuperGRIN lens include but is not limited to plasma-enhanced chemical vapor deposition (PECVD), sputtering, thermal evaporation, ebeam evaporation, or ion-assisted deposition (IAD). In a preferred embodiments, the IAD is used as it gives the optimum layer thickness uniformity.

At 1112, a metal hard-mask is deposited. As shown in FIG. 12, a structure 1230 is obtained. The structure 1230 includes a SuperGRIN lens stack 1232 and a metal hard-mask 1234. The SuperGRIN lens stack 1232 includes alternating layers of Si and SiO₂.

In various embodiments, the metal hard-mask may include but is not limited to nickel/titanium (Ni/Ti), chromium/titanium (Cr/Ti) or aluminium (Al). In a preferred embodiment, the metal hard-mask includes Ni/Ti with minimum grain size. In various embodiments, the Ni/Ti hard-mask may be deposited by but not limited to sputtering, electron-beam evaporation, thermal evaporation, or Filtered Cathodic Vacuum Arc technology (FCVA). In a preferred embodiment, FCVA is used as Ni has a grain size of about 5 nm and that the side-wall roughness of dry-etched SuperGRIN stack may be minimized.

Subsequently at 1112, photolithography may be performed to define a SuperGRIN lens area. As shown in FIG. 12, a structure 1236 is obtained. The structure 1236 includes a photoresist 1238.

Subsequently at 1112, the metal hard-mask 1234 may be patterned by RIE to form vertical side walls, similar to the embodiment shown in process flow A 820a of FIG. 8.

In alternative embodiments, a patterned metal hard-mask may be formed by electroplating of Ni in patterned openings of negative photo-resist (e.g. SU-8), similar to the embodiment shown in process flow B 820b of FIG. 8. After Ni hard-mask is electroplated, the negative photo-resist is removed either by dry etching or by removing in appropriate solvents.

At 1114, after the formation of patterned metal hard-mask, a SuperGRIN lens with vertical side walls may be formed by deep RIE (DRIE) for example by inductive coupled plasma (ICP) RIE, corresponding to the patterned metal hard-mask. The etching process is performed until the metal etch stop layer 1218 is reached or exposed. As shown in FIG. 12, a structure 1240 is obtained. The structure 1240 includes a patterned metal hard-mask 1242 with vertical side walls and a SuperGRIN lens 1244.

In various embodiments, the etchant gas or gases used for the ICP-RIE have at least substantially equal etch rates for silicon and silicon dioxide so as to maintain minimal differential etch rates of the layers of Si and SiO₂, in order to prevent preferential etching of between the layers of Si and the layers of SiO₂ to ensure vertical and smooth side-wall at the input facet of the SuperGRIN lens. The etchant gas used may include but is not limited to SF₆, CHF₃ or CF₄, in combination with Ar or O₂.

At 1116, photolithography and RIE of the metal etch stop layer 1218 are carried out to define and form contact pads and routing lines on the metal etch stop layer 1218, where the metal etch stop layer 1218 also functions as a metal-1 layer for electronic and photonic devices that may be integrated. In an electronics integrated circuits (IC) chip, a number of metal layers are provided. The metal-1 layer refers to the first metal layer after the first dielectric layer that covers the bottom Si structres or layer (e.g. Si substrate). In various embodiments, tungsten (W) via may be provided to connect the metal-1 layer to the bottom diffusion layer of the chip.

Subsequently at 1116, the photoresist 1238 and the patterned metal hard-mask 1242 are removed, for example, by differential wet or dry etching (e.g. fluorine-based etching). For example, Ni hard-mask may be removed by wet etchants which etch Ni but does not etch the metal-1 routing lines. As an example and not limitations, the metal etch stop layer 1218, functioning also as the metal-1 layer, may be aluminium (Al) as Al is not etched by fluorine-based dry etch chemistry. In addition, Al is used in metal layers for integrated circuits.

As shown in FIG. 12, a structure 1246 is obtained. The structure 1246 includes photoresist 1248, a contact pad 1250 and a routing line 1251. For clarity and illustration purposes, one contact pad 1250 and one routing line 1251 are shown in structure 1246. However, it should be appreciated that the structure 1246 may include a number of contact pads and a number of routing lines.

At 1118, a layer of passivation oxide is deposited after the photoresist 1248 has been removed. As shown in FIG. 12, a structure 1252 including a layer of passivation oxide 1254 is obtained.

In various embodiments, the layer of passivation oxide (e.g. SiO₂) 1254 may be deposited by high-density plasma enhanced (high deposition rate) chemical vapor deposition (PECVD). The thickness of the passivation layer 1254 may be at least 1.5 μm (i.e. ≧1.5 μm) to minimise optical loss to other layers.

At 1120, formation of a V-groove is carried out. A layer of silicon nitride (SiNx) hard-mask layer is deposited. Photolithography is then performed to define an opening area corresponding to a region for forming the V-groove. As shown in FIG. 12, a structure 1254 including a layer of SiNx hard-mask 1256 and photoresist 1258 is obtained.

Subsequently at 1120, at the opening area, the layer SiNx hard-mask 1256 is first removed by RIE, followed by DRIE of the underlying BOX 1206 to expose the underlying Si substrate 1204. The wafer is then dipped in a potassium hydroxide (KOH) or a TMAH (tetra methyl ammonium hydroxide) solution for anisotropic wet etching of the Si substrate 1204 to form a V-groove, for optical fiber placement. The wet etching process is a self-stopping process, where the etching process stops when the V-groove is formed.

Subsequently at 1120, a separate deep trench in the transverse direction at the V-groove head-end is formed by DRIE in order to remove the slope (e.g. having an angle of about (54.7°) of the V-groove formed by the anisotropic wet etching, for the placement of optical fiber in the V-groove for butt-coupling to an ouput facet of the SuperGRIN lens. Alternatively, the deep trench at the V-groove head-end may be formed by cutting through the Si substrate using a shallow saw-cut with a dicing blade.

As shown in FIG. 12, a structure 1260 is obtained. The structure 1260 includes an opening area 1262 for forming the V-groove, the V-groove 1264 and a deep trench 1266 at the head-end of the V-groove 1264. As shown for the structure 1260, the SuperGRIN lens 1244 has an output facet 1268 for butt-coupling to an optical fiber placed or mounted on the V-groove 1264.

Subsequently at 1120, the layer of SiNx is removed by placing the wafer in boiling H₃PO₄.

In alternative embodiments, at 1120, photo-sensitive BCB (benzocyclobutene) or polyimide may be used as a photoresist for DRIE of the underlying layer of passivation oxide 1214 and BOX 1206, instead of forming the layer of silicon nitride (SiNx) hard-mask layer 1256 for the etching process.

In alternative embodiments, at 1120, a silicon deep etching process such as the

Bosch Process may be employed to form a deep groove or trench for optical fiber placement.

In alternative embodiments, at 1120, the wet etching process for forming the V-groove may be replaced by a deep RIE (DRIE) process to form a rectangular deep groove or trench for optical fiber placement.

At 1122, formation of flip-chip bumps is carried out. Photolithography is performed and areas of metal-1 designated as bump pads are etched by RIE to expose the metal-1. The bump pads may be deposited by e-beam evaporation and photoresist lift-off or by electroplating on the exposed metal-1. As shown in FIG. 12, a structure 1270 including a flip-chip bump (e.g. a bump pad) 1272 is obtained. The flip-chip bump 1272 may include metals, for example AuSn (e.g. 80% Au-20% Sn) or PbSn (e.g. 37% Pb-63% Sn).

It should be appreciated that the processes performed at 1122 may be optional.

At 1124, photolithography and RIE are carried out to open a bond-pad area, by removing the layer of passivation oxide (or dielectrics) 1254 at the pad areas. The bond-pad areas may be used for wire-bonding in a later process. Subsequently, the PIC chip is diced from the wafer, and placed or mounted on a printed-circuit-board (PCB) substrate by a standard die-attached process. Subsequently, wire-bonding from the PIC chip to the bond-pads on the PCB substrate may be performed.

At 1126, a single mode optical fiber is placed on the V-groove. As shown in FIG. 12, a structure 1274 is obtained, where an optical fiber 1276 (e.g. a single mode fiber) is placed on the V-groove 1264, with the fiber core 1278 of the optical fiber 1276 at least substantially aligned with the SuperGRIN lens 1244. For clarity and illustration purposes, the PCB substrate is not shown.

Subsequently at 1126, a separately prepared Si V-grooved substrate piece (e.g. a capping substrate) is capped on the single mode fiber to press down or secure the fiber on the underlying V-groove. The optical fiber may be immobilized in the V-groove by flowing a curable resin adhesive or epoxy into the V-groove. The epoxy may be cured for example by a standard thermal process or preferably by ultra-violet (UV) radiation. Subsequently, the bond-pads are connected to the PCB substrate by wire-bonding.

In various embodiments, a separate V-groove capping substrate may be individually diced and prepared for capping individual optical fiber on each V-groove on the Si-substrate.

As shown in FIG. 12, a structure 1280 is obtained, including a capping substrate 1282 with a V-groove 1284 for securing the optical fiber 1276 with an underfill epoxy 1286 to the V-groove 1264 of the bottom Si substrate 1204. The capping substrate 1282 includes a flip-chip bump 1288 for contacting the flip-chip bump 1272 of the PIC chip. For clarity and illustration purposes, the PCB substrate is not shown.

In alternative embodiments, the top capping substrate may be secured to the bottom Si substrate of the PIC chip by a re-flow process of the flip-chip bumps (e.g. flip-chip bonding). The flip-chip bonding process is described later. For example, the flip-chip bonding process may be used when a single V-groove capping substrate with an arrangement of V-grooves complementary to the arrangement of the V-grooves on the platform Si-substrate is used to secure the linear fiber array when the capping substrate is capped down.

In various embodiments, the epoxy used preferably has a refractive index that is at least substantially similar to the refractive index of the cladding of the optical fiber in order to minimize optical power leakage. In addition, the epoxy may alleviate any problem due to the difference in thermal expansion coefficients of the optical fiber with the Si substrates.

It should be appreciated that while the various structures shown in FIG. 12 include one of each element or structure, e.g. the SuperGRIN lens 1244, the V-groove 1264, and the flip-chip bump 1272, there may be a plurality of such element or structure, and correspondingly the process of the embodiment of FIG. 11 may be used for fabricating a plurality of such element or structure.

The process flow 1100 illustrates the formation of the V-groove 1264 at 1120, towards the end of the process flow 1100. This minimises the possibility of unnecessary material being deposited on the V-groove and also of over-etching into the Si substrate 1202, to ensure placement accuracy of the optical fiber 1276.

In alternative embodiments, the V-groove 1264 may be formed at 1102 after the formation of SOI layer 1208 on the Si[110] substrate 1204. Processes of the embodiment of FIG. 11 are subsequently performed, excluding the formation of a V-groove at 1120. Therefore, the layer of passivation oxide (e.g. SiO₂) 1214 and the metal etch stop layer 1218, for example, may be deposited on the V-groove 1264, and which are subsequently removed following the processes of the embodiment of FIG. 11. In embodiments where the V-groove 1264 is formed at 1102, the deep silicon trench 1266 at the head-end of the V-groove 1264 is preferably etched at 1120 after the removal of the thick layer of passivation oxide 1254 that protects the SuperGRIN lens 1244. This minimises the possibility of unnecessary materials being deposited into the deep silicon trench 1266.

However, there may be challenges involved in pre-forming the V-groove at 1102 as the Si substrate 1204 may be over-etched or materials remaining on the surface of the V-groove 1264, which may cause fiber placement error for the passive alignment.

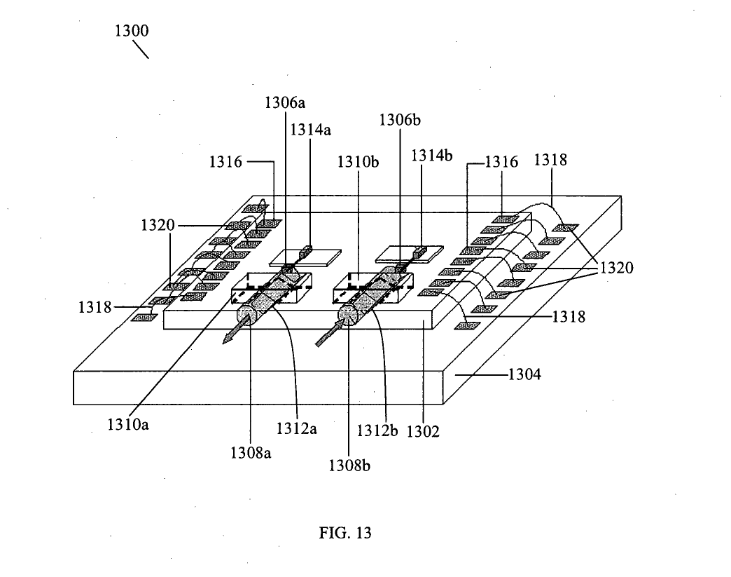

FIG. 13 shows a schematic perspective view of a PIC chip 1302 on a PCB substrate 1304, according to various embodiments, following the processes of FIGS. 11 and 12.

As shown in FIG. 13, the PIC chip 1302 includes a first SuperGRIN lens 1306a, a second SuperGRIN lens 1306b, a first single mode fiber 1308a, a second single mode fiber 1308b, a first capping substrate 1310a, a second capping substrate 1310b, a first V- groove 1312a and a second V-groove 1312b. The first single mode fiber 1308a is placed on the first V-groove 1312a and the the second single mode fiber 1308b is placed on the second V-groove 1312b. The first capping substrate 1310a also includes a V-groove for capping and securing the first single mode fiber 1308a to the first V-groove 1312a while the second capping substrate 1310b also includes a V-groove for capping and securing the second single mode fiber 1308b to the second V-groove 1312b.

The PIC chip 1302 further includes a first photodiode 1314a and a second photodiode 1314b. The first photodiode 1314a, the first SuperGRIN lens 1306a and the first single mode fiber 1308a are at least substantially optically aligned with each other while the second photodiode 1314b, the second SuperGRIN lens 1306b and the second single mode fiber 1308b are at least substantially optically aligned with each other.

The PIC chip 1302 further includes a plurality of bond-pads, for example as represented by 1316 for three bond pads, which are connected via a plurality of wire connections, for example as represented by 1318 for three wires, to a plurality of bond pads, for example as represented by 1320 for five bond pads, on the PCB substrate 1304.

The PIC chip 1302 may be interfaced to a dual-fiber module (not shown) to form a PIC dual-port (or dual-fiber) interface module package.

It should be appreciated that while FIG. 13 shows two for each of the SuperGRIN lens, single mode fiber, V-groove, capping substrate and photodiode, any number for each of the SuperGRIN lens, single mode fiber, V-groove, capping substrate and photodiode may be provided on the PIC chip 1302, for example three, four or five. Therefore, the process flow 1100 of FIG. 11 may be similarly applied for forming a PIC multi-port (or multi-fiber) interface module package. In such embodiments, a mask layout with multiple opening slots configured to define regions on the Si-substrate for forming multiple V-grooves may be used. The center-to-center spacing between V-grooves may be at least about 250 μm in conformity with industry standards requirement. Similarly, a mask layout for defining and forming the SuperGRIN lenses may be configured to form multiple SuperGRIN lenses or couplers with a center-to-center spacing of at least about 250 μm.

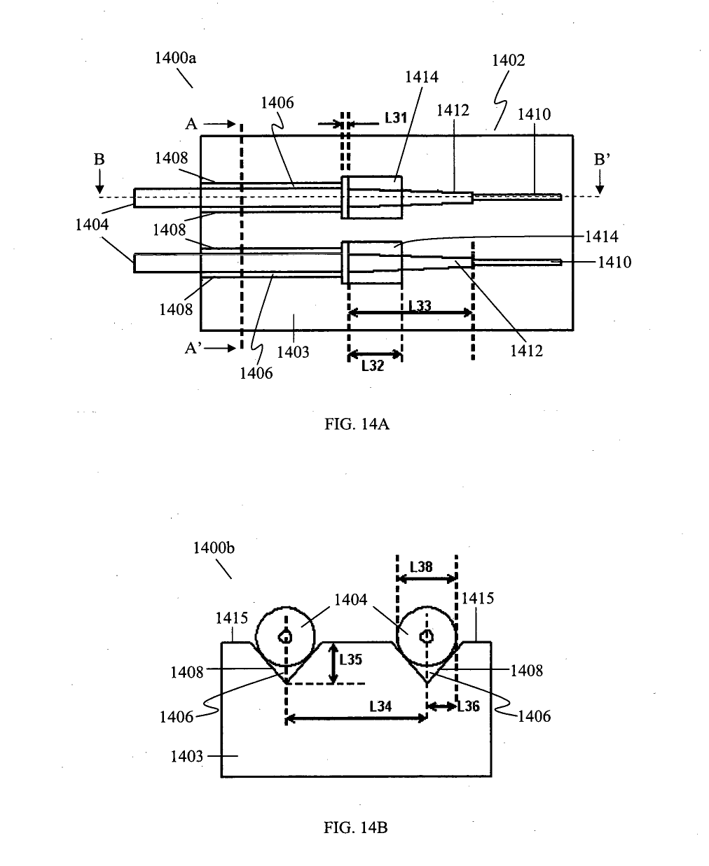

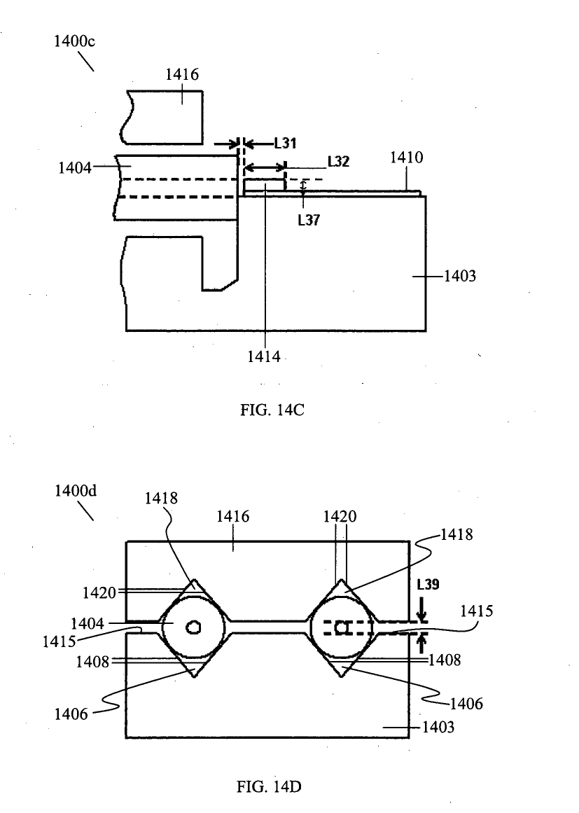

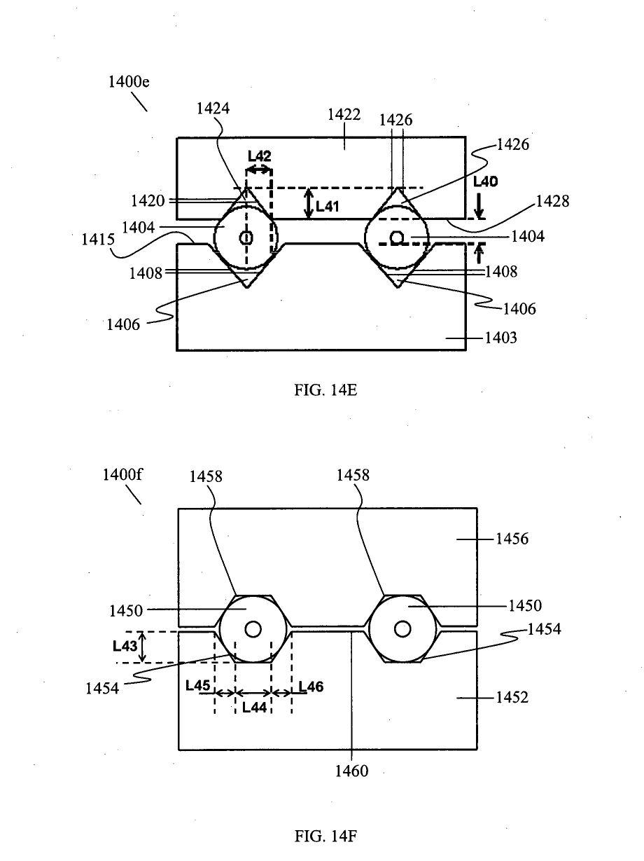

FIGS. 14A to 14F show different views of an EPIC-Fiber Optical Module, according to various embodiments, to illustrate the various dimensions relating to the platform or EPIC chip and the capping substrate.

FIG. 14A shows a top view 1400a of an EPIC chip 1402 configured to interface with a dual-fiber module including two single mode optical fibers 1404, while FIG. 14B shows a cross-sectional view 1400b taken along the line A-A′ of FIG. 14A. The EPIC chip 1402 includes a substrate (e.g. Si[110] substrate) 1403. For clarity purposes, a capping substrate is not shown in FIGS. 14A and 14B.

The two optical fibers 1404 are positioned on V-grooves 1406 having V-groove planes 1408. The V-grooves 1406 are etched into the substrate 1403. The EPIC chip 1402 includes two waveguides 1410 (e.g. Si-photonic waveguides), incorporating lateral up-tapered waveguides 1412. The EPIC chip 1402 further include two SuperGRIN lenses 1414.

FIG. 14C shows a cross-sectional view 1400c taken along the line B-B′ of FIG. 14A, while FIG. 14D shows a cross-sectional view 1400d taken along the line A-A′ of FIG. 14A. A capping substrate 1416 is shown in FIGS. 14C and 14D. The capping substrate 1416 include two V-grooves 1418 with V-groove planes 1420. The V-grooves 1418 may be at least substantitally similar to the V-grooves 1406 of the EPIC chip 1402.

FIG. 14E shows a cross-sectional view 1400e taken along the line A-A′ of FIG. 14A, with an alternative capping substrate 1422 having shallow V-grooves 1424 with V-groove planes 1426. The capping substrate 1422 may be used in embodiments incorporating a relatively larger spacing or gap between the surface 1415 of the substrate 1403 of the EPIC chip 1402 and the surface 1428 of the capping substrate 1422. As an example, the capping substrate 1422 may be used in embodiments where a flip-chip bonding method is used to secure the capping substrate 1422.

In various embodiments, the capping substrates 1416, 1422, are placed on the EPIC chip 1402 such that the V-grooves 1418, 1424, are inverted to be complementary with the V-grooves 1406 of the EPIC chip 1402 to cap and secure the optical fibers 1404. As shown in FIGS. 14D and 14E, each of the V-grooves 1406 corresponds to each of the respective V-grooves 1418, 1424, when the respective capping substrates 1416, 1422, is positioned over the substrate 1403.

The various dimensions shown in FIGS. 14A to 14E are illustrated as below:
L31, being the gap between the SuperGRIN lens 1414 and the optical fiber 1404, may be variable depending on the alignment of the masks and variations in the fabrication processes. In various embodiments, L31 may be in a range of between about 0 μm to about 5 μm, e.g. a range of between about 0 μm to about 3 μm or a range of between about 2 μm to about 5 μm. In embodiments where L31 is non-zero, an index-matching fluid may flowed into the gap L31 to facilitate in minimising reflection and maximising optical coupling between the respective SuperGRIN lens 1414 and the respective optical fiber 1404.
L32, being the length of the SuperGRIN lens 1414, may be approximately 18 μm for a Si/SiO₂ multilayer SuperGRIN lens with a stack thickness of about 7.5 μm. However, it should be appreciated that L32 may be in a range of between about 10 μm to about 22 μm, e.g. a range of between about 10 μm to about 15 μm or a range of between about 15 μm to about 22 μm.
L33 may be approximately 500 μm for the lateral up-taper Si-photonic waveguide 1412. However, it should be appreciated that L33 may be in a range of between about 50 μm to about 500 μm, e.g. a range of between about 50 μm to about 300 μm, a range of between about 50 μm to about 150 μm or a range of between about 200 μm to about 500 μm.
L34 may be approximately 250 μm for the center-to-center spacing of optical fibers 1404. However, it should be appreciated that L34 may be in a range of between about 250 μm to about 500 μm, e.g. a range of between about 250 μm to about 400 μm or a range of between about 350 μm to about 500 μm.
L35, being the depth of the V-grooves 1406, may be approximately 103.3 μm such that the fiber cores having a diameter of approximately 10 μm are just above the horizon surface 1415 of the substrate 1403. In various embodiments, the depth of the V-grooves 1406 may be controlled by controlling the duration and the temperature of the KOH wet etch process for etching the V-grooves 1406. The final V-groove depth is dependent on the width of the V-groove. For example, the depth of a V-groove (e.g. 1406) for a standard optical fiber (e.g. 1404) with a fiber core positioned about 1 μm above the surface (e.g. 1415) of the Si-substrate (e.g. 1403) is about 101.6 μm.
L36 may be approximately 72 μm to 73 μm for the projected horizontal distance of the V-groove planes (e.g. [111]-planes) 1408 at an angle of approximately 54.74° from the surface 1415.
L37, being the total thickness of the multi-layer SuperGRIN lens stack, may be in a range of between about 7 μm to about 12.5 μm, e.g. a range of between about 7 μm to about 10 μm or a range of between about 9 μm to about 12.5 μm.
L38 may be apprixmately 125 μm, being the diameter of a bare single mode fiber.
L39 may be approximately 10 μm, at least substantially equal to the diameter of the fiber core. For such a tight spacing, the optical fibers 1404 may be secured to the V-grooves 1406 by, for example, a UV-curable epoxy or adhesives.
L40 may be approximately 50 μm, being the spacing or gap between the surface 1415 of the substrate 1403 and the surface 1428 of the capping substrate 1422. However, it should be appreciated that L40 may be in a range of between about 5 μm to about 67.5 μm, e.g. a range of between about 5 μm to about 50 μm, a range of between about 5 μm to about 25 μm, a range of between about 20 μm to about 67.5 μm or a range of between about 20 μm to about 50 μm.
L41 may be approximately 63.3 μm, being the depth of the V-grooves 1426 of the capping substrate 1422. However, it should be appreciated that L41 may be in a range of between 0 μm to about 104 μm, e.g. a range of between 0 μm to about 50 μm, a range of between about 10 μm to about 80 μm, a range of between about 20 μm to about 60 μm or a range of between about 30 μm to about 50 μm.
L42 is the distance between the centre of the fiber core (or the centre of the V-groove 1426) to the edge of the V-groove 1426. L42 may be approximately 72 μm for supporting a standard single-mode fiber. However, it should be appreciated that L42 may be in a range of between about 72 μm to about 74 μm, for supporting a standard single-mode fiber or a small-core single-mode fiber.

FIG. 14F shows a cross-sectional view 1400f of an EPIC chip configured to interface with a dual-fiber module, including two single mode optical fibers 1450. The EPIC chip includes a substrate (e.g. Si[110] substrate) 1452 having U-grooves 1454 where the two optical fibers 1450 are positioned respectively. A capping substrate 1456 with U-grooves 1458 is provided to secure the two optical fibers 1450. The various dimensions for the U-grooves 1454 and 1458 shown in FIG. 14F are that L43 may be about 70 μm, L44 may be about 40 μm, while L45 and L46 may be about 50 μm.

In various embodiments, for a standard single-mode fiber (e.g. 1450) with a fiber core positioned about 1 μm above the surface (e.g. 1460) of the Si-substrate (e.g. 1452), L43 may be in a range of between about 56 μm to about 101 μm, e.g. a range of between about 60 μm to about 90 μm or a range of between about 70 μm to about 80 μm. L44 may be in a range of between zero (0 μm) to about 65 μm, e.g. a range of between 0 μm to about 40 μm or a range of between about 20 μm to about 50 μm. L45 and L46 may be in a range of between about 36 μm to about 70 μm, e.g. a range of between about 40 μm to about 60 μm or a range of between about 45 μm to about 55 μm.

It should be appreciated that various embodiments may include a combination of V-grooves and U-grooves for the platform or EPIC chip and the capping substrate. In addition, while FIGS. 14A to 14E show an EPIC chip interfaced to a dual-fiber module, substantially similar dimensions may be applied to embodiments of an EPIC chip interfaced to a multi-fiber module.

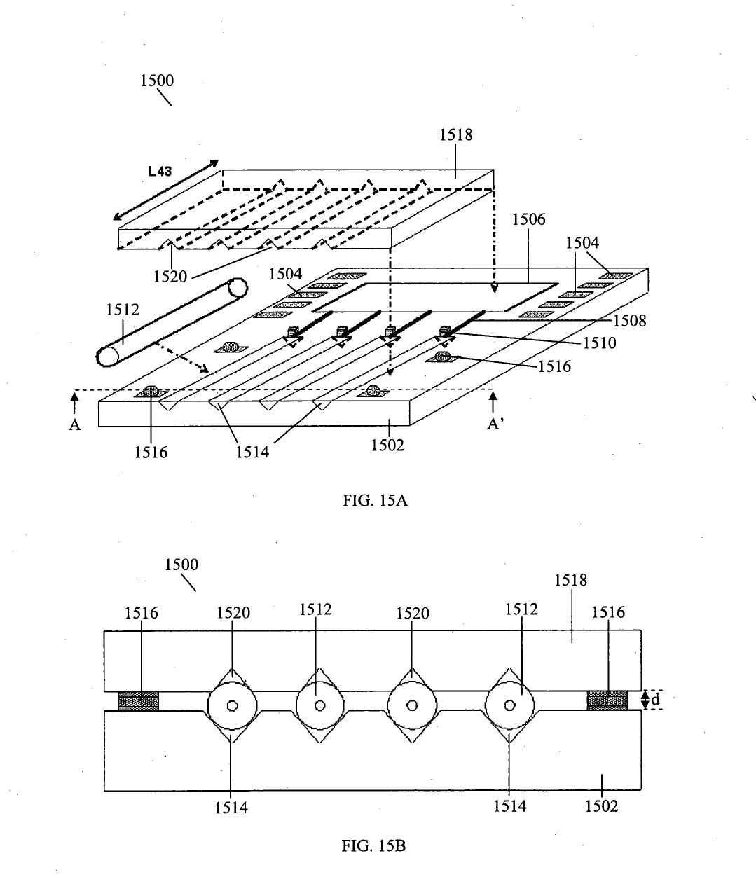

Various embodiments may provide the use of a V-groove capping substrate with an arrangement of V-grooves complementary to the arrangement of the V-grooves on the platform substrate, as shown in FIGS. 15A and 15B. The V-groove capping substrate is configured to secure the linear fiber array when the capping substrate is capped down. The V-groove capping substrate may be secured to the platform substrate by, for example, flip-chip bonding.

FIG. 15A shows an exploded perspective view of an EPIC chip 1500 with a substrate (e.g. Si[110] substrate) 1502, configured to interface with a multi-port (multi-fiber) optical module, according to various embodiments. The EPIC chip 1500 may include a number of wire bond pads, for example as represented by 1504 for three wire bond pads, an electronics-photonics integrated circuit or region 1506 where photonic components and devices and electronic circuits, components and devices may be positioned, a number of waveguides (e.g. Si-photonic waveguides), as represented by 1508 for one waveguide, a number of SuperGRIN lenses, as represented by 1510 for one lens and a number of optical fibers (e.g. single mode fibers), as represented by 1512 for a single fiber illustrated in FIG. 15A. As shown in FIG. 15A, the waveguides 1508 are optically coupled to the electronics-photonics integrated circuit 1506.

The subtrate 1502 includes a number of V-grooves, as represented by 1514 for two V-grooves, and a number of flip-chip bumps, as represented by 1516 for two flip-chip bumps. The EPIC chip 1500 further includes a capping substrate (e.g. Si) 1518 with a number of V-grooves, as represented by 1520 for two V-grooves, in order to secure the optical fibers 1512 in between the V-grooves 1514 and the V-grooves 1520. It should be appreciated that the number of V-grooves 1514 on the substrate 1502 is similar to the number of V-grooves 1520 of the capping substrate 1518. In various embodiments, L43 may be approximately 4 mm for the capping substrate 1518.

FIG. 15B shows a cross-sectional view taken along the line A-A′ of the embodiment of FIG.15A, when the EPIC chip 1500 is assembled with four optical fibers 1512. The inverted V-groove capping substrate 1518 is secured to the substrate 1502 by flip-chip bonding, for example by a re-flow process of the flip-chip bumps 1516. Therefore, the flip-chip bumps 1516 may be configured as interconnects between the capping substrate 1518 and the substrate 1502. In various embodiments, the V-grooves 1520 of the capping substrate 1518 may be shallow such that the imtermediate spacing, d, may be approximately 50 μm to accommodate the size of the flip-chip bumps 1516.

The flip-chip bumps 1516 may be lead-free solder having a composition of gold/tin (Au/Sn), tin/bismuth (Sn/Bi), tin/indium (Sn/In) or tin/silver (Sn/Ag). and others. In one embodiment, a Au/Sn composition at a ratio of about 80/20 having a melting point of less than 300° C. may be used. It should be appreciated that other compositions may be used.

It should be appreciated that while FIGS. 15A and 15B show an interface of the EPIC chip 1500 for a four-port (fiber) module, the EPIC chip 1500 may be used for interfacing with any number of ports, for example with a two-port module, a three-port module, a five-port module or any higher number of ports, with the corresponding number of components, such as the SuperGRIN lens, the Si-photonic waveguides and the V-grooves.

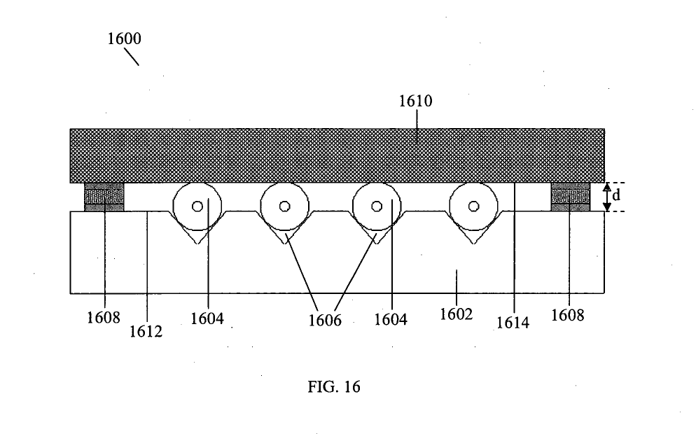

FIG. 16 shows a cross-sectional view of an EPIC chip 1600 configured to interface with a multi-port (multi-fiber) optical module, according to various embodiments. The EPIC chip 1600 includes a substrate (e.g. Si[110] substrate) 1602, a number of optical fibers (e.g. single mode fibers), as represented by 1604 for two fibers, and a number of V-grooves, as represented by 1606 for two V-grooves, on the substrate 1602 for placement of the optical fibers 1604. The EPIC chip 1600 may further include a number of flip-chip bumps 1608.

The EPIC chip 1600 further includes a capping metallic substrate (e.g. a metal stripe) 1610 configured to secure the optical fibers 1604 on the V-grooves 1606. The capping metallic substrate 1610 may be tied down or secured to the substrate 1602 by flip-chip bonding, for example by a re-flow process of the flip-chip bumps 1608, at the edges of the capping metallic substrate 1610. Therefore, the flip-chip bumps 1608 may be configured as interconnects between the capping substrate 1610 and the substrate 1602. In various embodiments, the intermediate spacing, d, may be approximately 67.5 μm to accommodate the size of the flip-chip bumps 1608. However, it should be appreciated that the intermediate spacing, d, may be in a range of between about 65 μm to about 67.5 μm from the surface 1612 of the substrate 1602 to the bottom surface 1614 of the capping metallic substrate 1610, depending on whether the respective optical fiber 1604 is small-core fiber having a core-radius of about 2.5 μm or a standard single-mode fiber having a core radius of about 5 μm. In embodiments where an SOI substrate is used, the SuperGRIN lens may be mounted on the surface of the buried oxide (BOX), where the thickness of the BOX is about 1 μm or about 2 μm. In such embodiments, d may be in a range of between about 68.5 μm to about 69.5 μm for a standard single-mode fiber or d may be in a range of between about 66 μm to about 67 μm for a small-core fiber.

In alternative embodiments, snap-adhesives, which may be for example thermally cured, may be used in place of the flip-chip bumps 1608, to secure the capping metallic substrate 1610 to the substrate 1602. Snap-adhesives or snap cure adhesives are adhesive products that cure at moderately elevated temperatures (e.g. 110-180° C.) in seconds, and provide high performance properties that are common in an adhesive. An example of a snap cure adhesive that may be used is Bondline-6485 solvent free epoxy, which is designed for micro-electronic bonding, including chip, substrate attach and package sealing. The Bondline-6485 may be cured, for example at about 180° C. for about 1 minute or about 150° C. for about 30 minutes.

The flip-chip bumps 1516 may be lead-free solder having a composition of gold/tin (Au/Sn), tin/bismuth (Sn/Bi), tin/indium (Sn/In) or tin/silver (Sn/Ag). and others. In one embodiment, an Au/Sn composition at a ratio of about 80/20 having a melting point of less than 300° C. may be used. It should be appreciated that other compositions may be used.

The capping metallic substrate 1610 may be Kovar. Kovar is an iron-nickel-cobalt alloy and has a thermal expansion coefficient at least substantially similar to glass and Si.

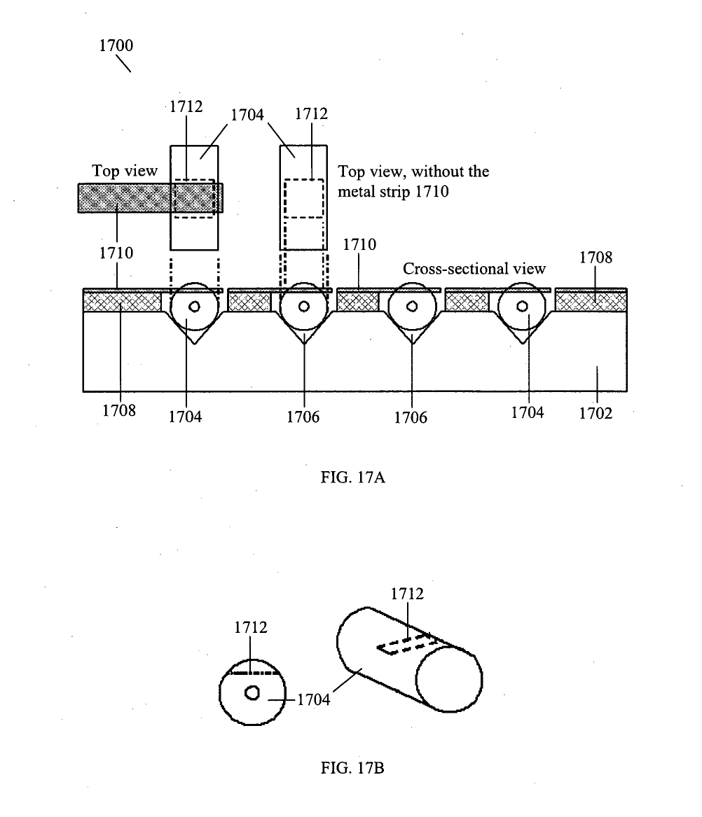

FIG. 17A shows a cross-sectional view of an EPIC chip 1700 configured to interface with a multi-port (multi-fiber) optical module, according to various embodiments. The EPIC chip 1700 includes a substrate (e.g. Si[110] substrate) 1702, a number of optical fibers (e.g. single mode fibers), as represented by 1704 for two fibers, and a number of V-grooves, as represented by 1706 for two V-grooves, on the substrate 1702 for placement of the optical fibers 1604.

As shown in FIG. 17A, the optical fibers 1704 may be tied-down or secured on the V-grooves 1706 by a latch-able mechanism. Each latch-able mechanism includes a polymer 1708, for example BCB (benzocyclobutene) or polyimide, that may be spin-coated on the substrate 1702. Each latch-able mechanism further includes a metal strip 1710 that may be deposited and patterned on the polymer 1708, with a length that is at least substantially overlapping an optical fiber 1704. The metal strip 1710 may be an alloy of gold (Au) with tin (Sn), zinc (Zn) or other metals. The interface between the polymer 1708 and the metal strip 1710 may be deposited with a third agent (e.g. a metal or other materials) configured to act as an adhesive between the polymer 1708 and the metal strip 1710. In various embodiments, the thickness of the polymer 1708 formed may be in a range of between about 40 μm to about 65 μm, e.g. a range of between about 50 μm to about 60 μm, such that the thickness may be about 50 μm. The polymer should be sufficiently thick so as not to interfere with the optical mode in the optical fiber 1704. In various embodiments, the thickness of the metal strip 1710 may be in a range of between about 500 μm to about 1 mm (1000 μm), e.g. a range of between about 500 μm to about 800 μm or a range of between about 700 μm to about 1 mm.

In various embodiments, the metal strip 1710 is inert towards potassium hydroxide (KOH), is substantially flexible and sufficiently malleable to latch down the optical fibers 1704 on the V-grooves 1706.

Each of the optical fibers 1704 may have a shallow groove 1712 formed or etched on the optical fibers 1704, as shown in FIGS. 17A and 17B, for the latching of the metal strip 1710 on the groove 1712 to secure the optical fiber 1704 on the V-groove 1706. The groove 1712 may be formed by etching. However, other processes may be used to form the groove 1712.

The method of forming the embodiment of FIG. 17A is now described by way of example and not limitations, and with reference to FIGS. 17A and 17B. Photosensitive BCB is spin-coated on a Si[110] substrate 1702, prior to anisotropic wet etching to form V-grooves 1706 on the substrate 1702. Photolithography is then performed to harden the BCB at portions of the substrate 1702 where V-grooves are not formed. Prior to the development of the exposed BCB, a metal layer is blanket deposited over the spin-coated BCB on the substrate 1702. Photolithography is subsequently performed to pattern the blanket deposited metal layer.

Then, portions of the metal layer corresponding to areas with no latching metal strips are etched away, for example by dry etching. Subsequently, the photoresist on the metal strips 1710 and the embedded exposed BCB are dissolved away in a solvent, for example acetone or any other suitable solvent, to expose the surface of the substrate 1702.

Anisotropic wet etching, for example by dipping into a solution of potassium hydroxide (KOH) or tetra-methyl ammonium hydroxide (TMAH) to form the V-grooves 1706, is then performed. As BCB has good resistivity to KOH etching, BCB serves as a mask for the formation or etching of the V-grooves 1706.

Bare optical fibers 1704 with a pre-formed groove 1712 on each fiber are positioned on a respective V-groove 1706 and latched or secured into position by the corresponding metal strip 1710.

In alternative embodiments, the V-grooves 1706 may be pre-fabricated on the substrate 1702 prior to the spin-coating of the photosensitive BCB and the formation of the metal strips 1710. Subsequently, the BCB is deposited, patterned and developed to expose areas of the substrate 1702 corresponding to the V-grooves 1706, for fiber placement. The metal strips 1710 are subsequently formed. As the metal strips 1710 are not exposed to anisotropic wet etching, for example by KOH, the requirement that the metal strips 1710 be inert may be relaxed.

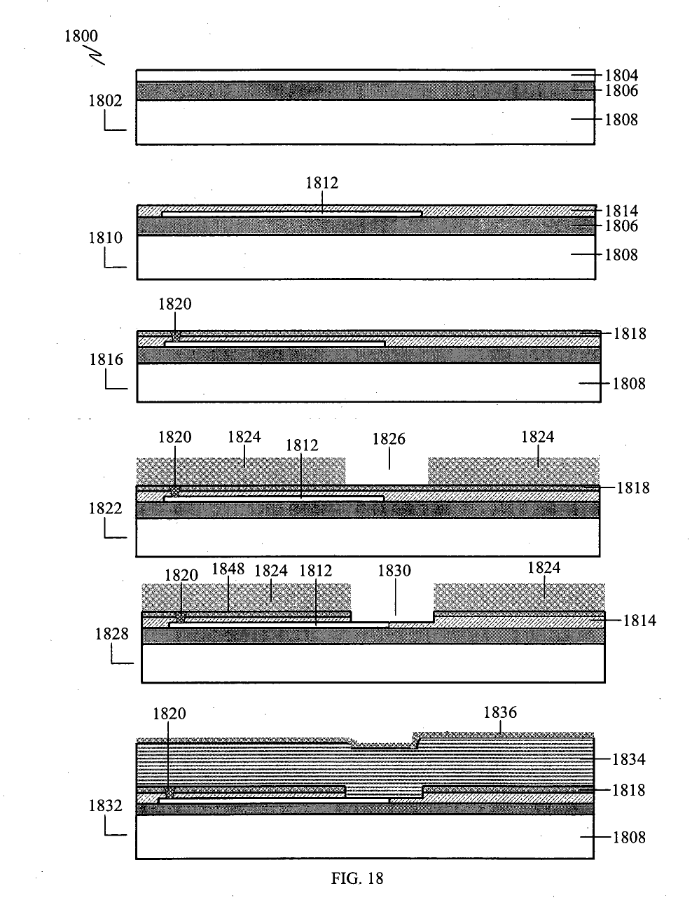

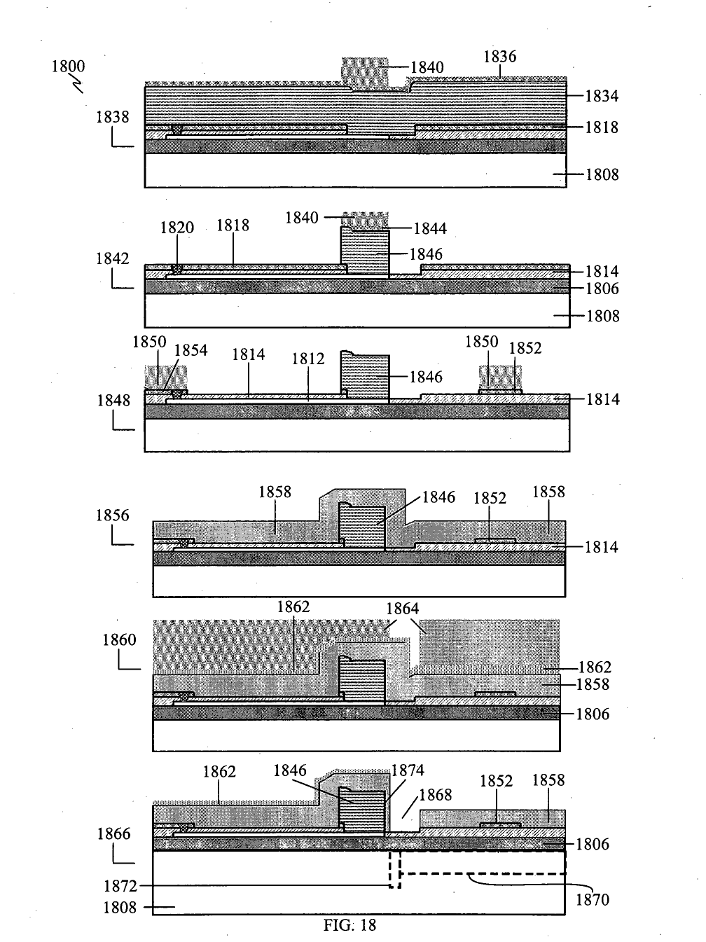

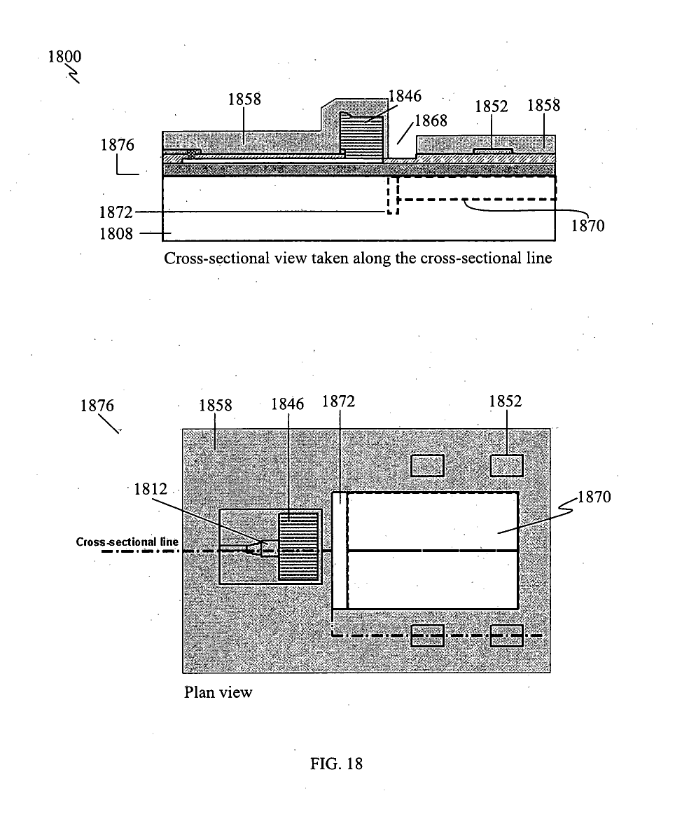

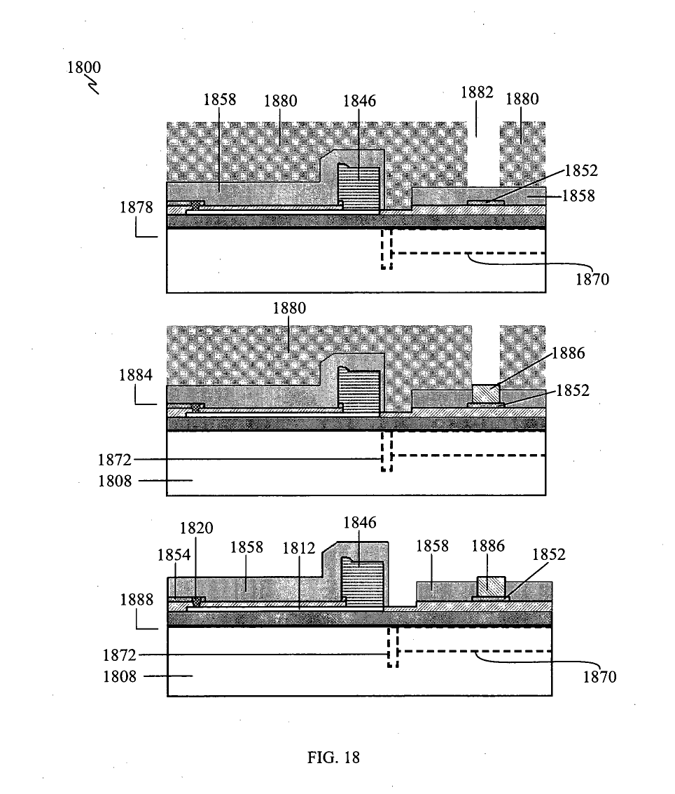

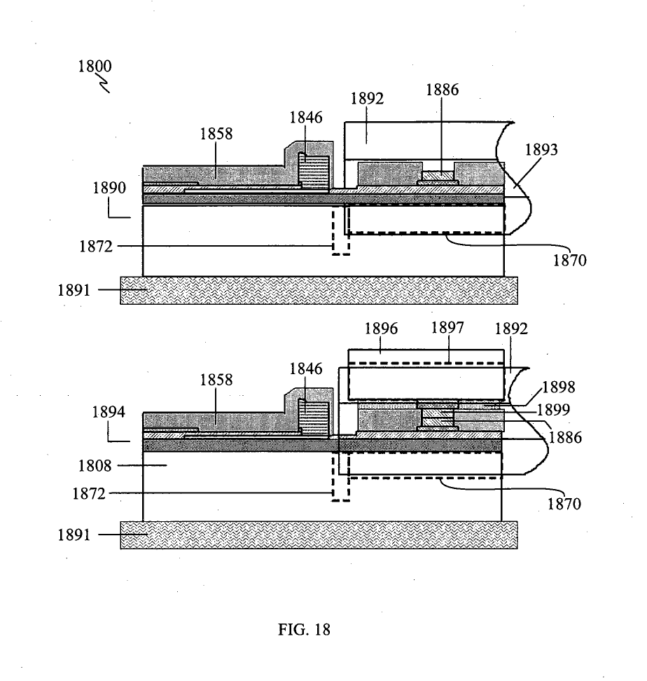

FIG. 18 shows a process 1800 of integrating a SuperGRIN lens on a photonic waveguide to a V-groove, according to various embodiments. A structure 1802 is prepared, where the structure 1802 includes an SOI substrate including an SOI 1804 having a thickness of about 320 nm and a BOX 1806 having a thickness of about 1000 nm, on a Si[110] substrate or wafer 1808. The SOI substrate may be custom-prepared using for example the ‘Smart-Cut’ process. The SOI 1804 may then be thinned to about 300 nm by a dry thermal oxidation process. A thin layer of thermal oxide of a thickness of about 15 nm may be formed on the SOI 1804 as a result of the dry thermal oxidation process. Subsequently, a thin layer of silicon nitride (SiNx) of a thickness of about 200 nm may be deposited, for example by LPCVD, to act as a hard-mask.

Photolithography with a photo-resist is then performed to pattern a Si-photonic waveguide (e.g. Si-channel waveguide) on the SOI 1804. RIE/ICP etching is performed to etch the SiNx hard-mask, the underlying thermal oxide and the SOI 1804 to form the Si-photonic waveguide, stopping at the BOX 1806. The photoresist is then removed by for example dry etching while the SiNx is removed, for example in a boiling phosphoric acid (H₃PO₄) solution. Subsequently, in embodiments incorporating active devices on the SOI 1804, ion-implantation and dopant annealing may be performed. A pre-metal dielectric or a layer of passivation oxide (e.g. SiO₂) of a thickness of about 500 nm is then deposited. As shown in FIG. 18, a structure 1810 including a Si-photonic waveguide 1812 and a layer of passivation oxide 1814 is obtained.

Subsequently, contact-vias are formed. In order to form the contact-vias, photolithography is performed to pattern and open areas of the pre-metal oxide (i.e. the layer of passivation oxide 1814) and an oxide RIE process is then carried out to form via openings, stopping on the underlying SOI 1804. A layer of aluminium (Al) of a thickness of about 1 μm is blanket deposited, including into the via openings of the contact-vias. The layer of aluminium acts as a metal etch stop layer during the DRIE of a SuperGRIN lens stack in a subsequent process. In various embodiments, the total thickness of the layer of aluminium and the layer of passivation oxide is approximately 1.5 μm. As shown in FIG. 18, a structure 1816 including a metal etch stop layer 1818 is obtained. For clarity and illustration purposes, one contact-via 1820 is shown in structure 1816. However, it should be appreciated that the structure 1816 may include a number of contact-vias.

Subsequently, photolithography is performed to define an opening for a coupler region (or mode-transformer coupler region) where a SuperGrin lens stack may be deposited into in a subsequent process. The coupler region at least substantially overlaps with termination end of the Si-photonic waveguide 1812. As shown in FIG. 18, a structure 1822 is obtained. The structure 1822 includes a photoresist 1824 with an opening 1826 corresponding to a coupler region.

Subsequently, dry etching is performed to etch the metal etch stop layer 1818 and the layer of passivation oxide 1814 in the coupler region to expose the Si-photonic waveguide 1812. As shown in FIG. 18, a structure 1828 is obtained. The structure 1828 includes a coupler region 1830. This may result in a configuration substantially similar to the embodiment of FIG. 4A.

Alternatively, the exposed Si-photonic waveguide 1812 may also be etched away, for example by dry etching, stopping at the BOX 1806. This may result in a configuration substantially similar to the embodiment of FIG. 4B.

The photo-resist 1824 is then removed, and the wafer dipped in a dilute hydrofluoric acid (DHF) solution (e.g. diluted with de-ionised water at 100:1) for about 30s to form an under-cut in the pre-metal oxide at the edge of the coupler region 1830.

A multi-layer SuperGRIN lens stack is deposited, followed by the deposition of nickel/titanium (Ni/Ti) of about 50 nm of titanium (Ti) and about 300 nm of nickel (Ni). Nickel acts as a hard-mask and may be deposited by Filtered Cathodic Vacuum Arc technology (FCVA). Ti functions as an adhesive layer to adhere Ni to the multi-layer SuperGRIN lens stack. The SuperGRIN lens stack may be deposited by ion-assisted deposition (IAD). As shown in FIG. 18, a structure 1832 is obtained. The structure 1832 includes a SuperGRIN lens stack 1834 and a metal hard-mask 1836. The SuperGRIN lens stack 1834 may include alternating layers of amorphous Si and SiO₂.

Subsequently, photolithography is performed to define a SuperGRIN lens area. As shown in FIG. 18, a structure 1838 including a photoresist 1840 is obtained.

Subsequently, the metal hard-mask 1836 may be patterned by RIE to form vertical side walls. ICP-RIE etching is then performed to etch the SuperGRIN lens stack 1834, stopping at the Al metal etch stop layer 1818. As shown in FIG. 18, a structure 1842 is obtained. The structure 1842 includes a patterned metal hard-mask 1844 with vertical side walls and a SuperGRIN lens 1846.

Subsequently, photolithography is performed to define contact pads and metal-1 routing lines. The Al metal etch stop layer 1818 is removed by dry etching except at areas corresponding to the contact pads and the routing lines. The photoresist 1840 and the Ni/Ti hard-mask 1844 are then removed, for example, by differential wet or dry etching, which does not etch the routing lines. As shown in FIG. 18, a structure 1848 is obtained. The structure 1848 includes photoresist 1850, a contact pad 1852 and a routing line 1854. For clarity and illustration purposes, one contact pad 1852 and one routing line 1854 are shown in structure 1848. However, it should be appreciated that the structure 1848 may include a number of contact pads and a number of routing lines.

Subsequently, the photoresist 1850 is removed and a layer of passivation oxide (e.g. SiO₂) of a thickness of about 2 μm is deposited. As shown in FIG. 18, a structure 1856 including a layer of passivation oxide 1858 is obtained.

Subsequently, a V-groove is formed. In order to form the V-groove, a layer of silicon nitride (SiNx) hard-mask of a thickness of about 300 nm is deposited for example by PECVD. Photolithography is then performed to define an opening area corresponding to a region for forming theV-groove. As shown in FIG. 18, a structure 1860 including a layer of SiNx hard-mask 1862 and photoresist 1864 is obtained.

Subsequently, at the opening area, the layer SiNx hard-mask 1862 is first removed by dry etching, followed by DRIE of the underlying BOX 1806 to expose the underlying Si substrate 1804. After the removal of the photoresist 1864, the wafer is dipped into a potassium hydroxide/isopropyl alcohol (KOH/IPA) solution for anisotropic wet etching of the Si substrate 1808 to form a V-groove, for optical fiber placement.

Subsequently, additional photolithography steps may be performed to form a deep trench for butt-coupling to an output facet of the SuperGRIN lens. As shown in FIG. 18, a structure 1866 is obtained. The structure 1866 includes an opening area 1868 for forming the V-groove, the V-groove 1870 and a deep trench 1872 at the head-end of the V-groove 1870. As shown for the structure 1866, the SuperGRIN lens 1846 has an output facet 1874 for butt-coupling to an optical fiber placed or mounted on the V-groove 1870. For clarity and illustration purposes, one V-groove 1870 is shown in the structure 1866. However, it should be appreciated that the structure 1866 may include a number of V-grooves.

Subsequently, the layer of SiNx 1862 is removed by dipping in a boiling H₃PO₄ solution. As shown in FIG. 18, a structure 1876 is obtained.

Photolithography is then performed to define a bond-pad opening, as shown by the structure 1878 including a photoresist 1880 and a bond-pad opening 1882.

Subsequently, RIE is performed to etch the layer of passivation oxide 1858 via the bond-pad opening 1882 to expose the contact pad 1852. A flip-chip solder metal bump is then electroplated on the contact pad 1852. As shown in FIG. 18, a structure 1884 including a solder metal bump 1886 deposited on the contact pad 1852 is obtained. In various embodiments, the solder metal may be a combination of gold/tin (Au/Sn).

Subsequently, the photoresist 1880 is removed by a lift-off, as shown by the structure 1888.

Alternatively, the solder metal bump 1886 may be deposited by e-beam evaporation, followed by lift-off of the photoresist 1880.

Subsequently, the EPIC chip is diced from the wafer, and placed or mounted on a printed-circuit-board (PCB) substrate. Conductive die-attach epoxy may be used to secure the EPIC die on the PCB substrate.

A bare optical fiber (e.g. a single mode optical fiber) is then placed on the V-groove 1870. As shown in FIG. 18, a structure 1890 is obtained, where the structure 1888 (i.e. the EPIC chip) is mounted or placed on a PCB substrate 1891. The structure 1890 includes an optical fiber 1892 placed on the V-groove 1870, with the fiber core 1893 of the optical fiber 1892 at least substantially aligned with the SuperGRIN lens 1846.

Subsequently, a separately prepared Si V-grooved substrate piece (e.g. a capping substrate) with flip-chip bumps is capped on the single mode fiber 1892 to press down or secure the fiber on the underlying V-groove. A flip-chip bump reflow process is then carried out in, for example a flip-chip reflow oven, to re-flow the flip-chip bumps.

Subsequently, the optical fiber 1892 may be immobilized in the V-groove 1870 by flowing a curable resin adhesive or epoxy into the V-groove 1870. The epoxy may be cured for example by a standard thermal process or preferably by ultra-violet (UV) radiation. Subsequently, wire-bonding from the EPIC chip to the bond-pads (not shown) on the PCB substrate 1891 may be performed.

As shown in FIG. 18, a structure 1894 is obtained, including a capping substrate 1896 with a V-groove 1897 for securing the optical fiber 1892, including an underfill epoxy 1898 to the V-groove 1870 of the Si substrate 1808. The capping substrate 1896 includes a flip-chip bump 1899 for contacting the flip-chip bump 1886 of the EPIC chip.

It should be appreciated that while the various structures shown in FIG. 18 include one of each element or structure, e.g. the SuperGRIN lens 1846, the V-groove 1870, and the flip-chip bump 1886, there may be a plurality of such element or structure, and the processes as described may be used for fabricating the plurality of such element or structure.

In addition, it should be appreciated that the descriptions relating to the embodiments of FIGS. 11 and 12 may be similarly applicable to the embodiment of FIG. 18.

### Fabrication and Experimental Data

A CMOS-compatible fabrication process suitable for mass-fabrication was used to fabricate an ultra-compact Si/SiO₂ multilayer super-high numerical aperture (e.g. an NA of >3) graded-index lens (SuperGRIN lens or GRIN lens) optical mode-size converter for integration to SOI-based photonic waveguide.

A 4-inch SOI substrate wafer with a buried oxide thickness of 1 μm first underwent dry oxidation to thin down the SOI to a target thickness of 300 nm. 200 nm of low-pressure chemical vapor deposition (LPCVD) silicon nitride (SiNx) was deposited on the wafer to function as a hard-mask. Patterns of multi-mode Si-waveguides of dimensions of 300 nm×3μm (thickness×width) were printed on the SOI substrate by contact-mode photolithography. For integrating the GRIN lens to the Si-waveguide, three masks layers were utilized.

The pattern was transferred to the SiNx hard-mask by reactive ion-etching (RIE) of SiNx. Without removing the photo-resist on the SiNx hard-mask, the Si-waveguides were formed by inductive-coupled plasma (ICP/RIE) etching of the SOI. The Si-waveguide terminates at 6 μm-wide at the chip-edge through Si up-taper at the output end. The photo-resist was removed by O₂-plasma etching and SiNx was removed by dipping wafer in boiling phosphoric acid.

Subsequently, 400 nm of plasma-enhanced chemical vapor deposition (PECVD) SiO₂ and, then, 50 nm of Al etch-stop (ES) layer were blanket deposited on the substrate. Physical openings of 60 μm×40 μm (width×length) were made at the Si-waveguide tips by photolithography, dry etching of Al and the underlying SiO₂ to expose the Si-waveguide tips. The Si-waveguide tips were also removed by ICP/RIE so that Si-waveguide may be butt-coupled to the multilayer SuperGRIN lens in a later process. After removal of photo-resist, Si/SiO₂ multilayer was blanket deposited onto the substrate. The underlying ES layer provides adhesion to the deposited Si/SiO₂ multilayer, and also functions to prevent over-etching into the underlying Si-waveguide during the etching of the Si/SiO₂ multilayer. Al was used for the ES-layer as it provides good adhesion to Si or SiO₂, and it also has low etch-rates in fluorine based RIE etching chemistry. No lift-off of Si/SiO₂ multilayer was observed after its deposition.

In order to fabricate on-wafer SuperGRIN lens with a well-defined and repeatable focal length L_{GRIN}, the SuperGRIN lens was defined and fabricated by ICP/RIE with vertical side-walls. A sufficiently thick electroplated Ni hard-mask was used. A thin layer of Cr(5 nm)/Au(20 nm) seed layer was first deposited on the substrate. The wafer substrate was sent for third-level photolithography using SU-8 negative photo-resist. Rectangular resist openings (dimensions: 50 μm×30 μm (width×length)) that overlapped with the previous openings that exposed the Si-waveguide tips, were made at the tip of the Si-waveguides. The extent of this overlap in the openings in the waveguide longitudinal direction defines the L_{GRIN} of the SuperGRIN lens.

Ni was then electroplated into the openings of the SU-8 resist. The electroplated-Ni grew from the metallic seed layer and conformed to the side-wall profile of the SU-8. SU-8 resist was used in the third mask photolithography as it has good vertical side-wall. About 500˜800 nm of Ni was electroplated into the openings of the SU-8 photo-resist. The SU-8 was removed by dry etching or dipping in boiling Remover-PG solvent for several minutes.

Using the electroplated-Ni as hard-mask, the Si/SiO₂ multilayer was etched in ICP/RIE with vertical side-wall using C₄F₈ chemistry. The etching stopped on the underlying Al-ES layer. After the etching of Si/SiO₂ multilayer, the Al-ES was removed by low-power Cl₂/BCl₃ RIE. Subsequently, the plated-Ni hard-mask was removed by dipping the substrate in a Piranha solution for a few seconds depending on its concentration. In the final step, about 1.5-2 μm thick passivation SiO₂ was deposited to protect the devices.

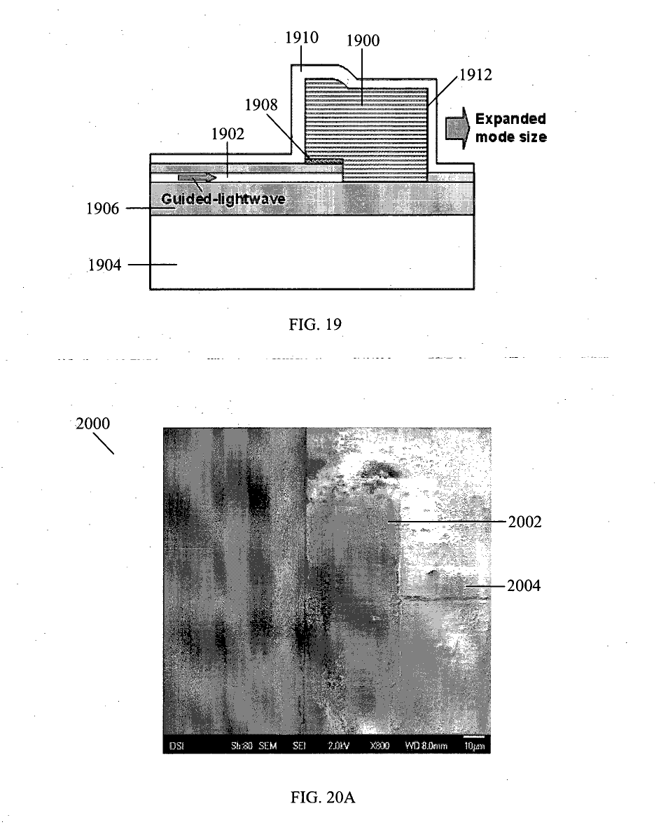

FIG. 19 shows a schematic diagram of a vertical cross-section of a SuperGRIN lens 1900 integrated to a Si-waveguide 1902 on an SOI substrate, according to various embodiments employing CMOS-compatible processes. Also shown in FIG. 19 is a Si substrate 1904, a buried oxide (BOX) 1906, a metallic etch-stop layer 1908, passivation oxide 1910, and an output facet 1912 of the SuperGRIN lens 1900.

FIG. 20A shows a scanning electron micrograph (SEM) image 2000 of a SuperGRIN lens 2002 integrated to a Si-waveguide 2004 on an SOI substrate, fabricated by a CMOS compatible process, according to various embodiments. The SuperGRIN lens 2002 is butt-terminated to the SOI-based Si-waveguide 2004. FIG. 20B shows a scanning electron micrograph (SEM) image 2006 of the embodiment of FIG. 20A, illustrating the optical output facet 2008 of the SuperGRIN lens 2002.

The fabricated SuperGRIN lens 2002 has 21 pairs of Si/SiO₂ multilayer, where the thickness of Si layers decreases and the thickness of SiO₂ layers increases from the bottom to the top of the SuperGRIN lens 2002. The total thickness of the Si/SiO₂ multilayer stack of the SuperGRIN lens 2002 was measured to be approximately 7.5 μm by a surface profiler. In addition, the fabricated SuperGRIN lens 2002 has a focal length L_{GRIN} of about 11.5 μm.

Measurements were made using a device-under-test (DUT) having a Si-waveguide with a 3 μm-wide termination at an input end and a 6 μm-wide termination at an output end, which is also butt jointto a Si/SiO₂ SuperGRIN lens (e.g. similar to the inset of FIG. 24). A discrete objective lens (60×, NA=0.65) was used to couple TE-polarized IR-laser light (λ=1550 nm) into the Si-waveguide at the input end, and a similar objective lens was used to image the optical near-field pattern of the mode at the SuperGRIN lens output facet onto an IR-camera.

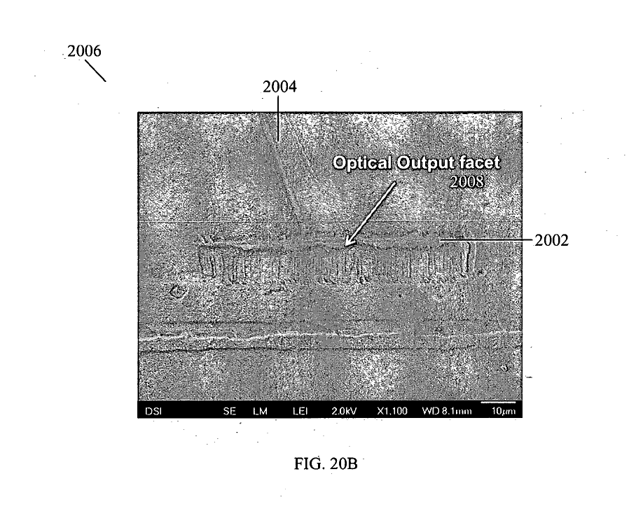

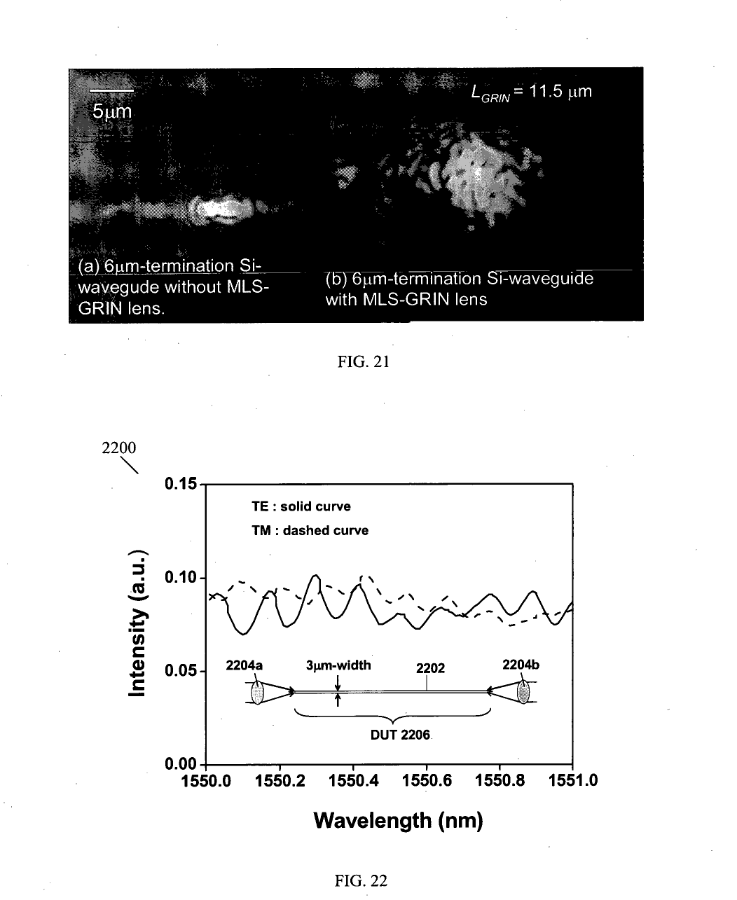

FIG. 21(a) shows an optical output image of an optical mode from a 6 μm-wide Si-waveguide, at the output of the waveguide, without a SuperGRIN lens while FIG. 21(b) shows an optical output image of an optical mode from a 6 μm-wide Si-waveguide, at the output of the waveguide, with a SuperGRIN lens (L_{GRIN}=11.5 μm) butt-terminated to the waveguide. The Si-waveguide used has a thickness of about 300 nm. As shown in FIG. 21(b), the optical mode expanded substantially equally, both horizontally by the lateral Si up-taper and vertically by the SuperGRIN lens, by about 6 μm-7 μm. Therefore, a vertical optical mode size transformation from about 300 nm (from the waveguide) to about 6 μm to about 7 μm at the output facet of the SuperGRIN lens was achieved. In addition, no significant optical power reduction was observed when the input light was changed from TE to TM-polarized light (results not shown). The scale bar represents 10 μm for FIGS. 21(a) and 21(b).

By using a lensed fiber-probe to couple light into a Si-waveguide at the input, and a standard single-mode fiber (SMF28) to couple light out from a SuperGRIN lens, the SuperGRIN lens to SMF28 coupling loss may be evaluated by subtracting the fiber-probe input coupling loss and propagation loss through the DUT from the overall device insertion loss from fiber-probe to SMF28.

FIG. 22 shows a plot 2200 of Fabry-Perot spectra of a 3 μm-wide Si-waveguide, using lens objectives to couple light into/out of the Si-waveguide. The plot 2200 of Fabry-Perot spectra was obtained for TE polarized light (results as represented by the solid line) and TM polarized light (results as represented by the dotted line) from a tunable IR-laser coupled into a 3 μm-wide Si-waveguide without Si up-tapers at both ends. As shown in the inset of FIG. 22, IR-light was coupled into the Si-waveguide 2202 through a lens objective 2204a and out of the Si-waveguide 2202 through a lens objective 2204b. The Si-waveguide 2202 has a thickness of about 300 nm.

From the peak-valley ratios, the propagation losses for TE-polarized, TM-polarized, and random polarized light were measured to be about 22.3 dB/cm, about 39 dB/cm, and about 23 dB/cm respectively. For a total length of about 2228.5 μm for the DUT 2206, the power loss due to propagation was about 5 dB for random polarization.

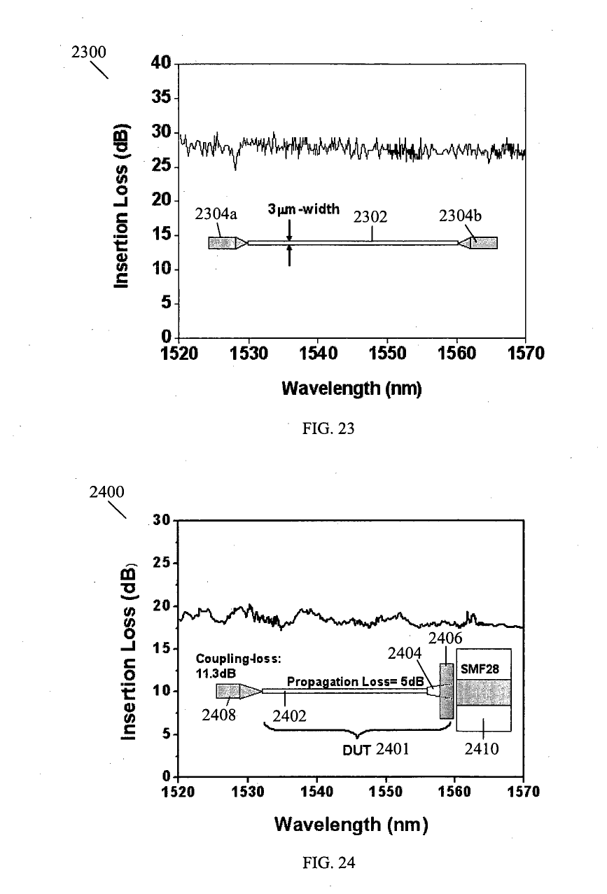

FIG. 23 shows a plot 2300 of insertion-loss spectrum of a 3 μm-wide and 2228.5 μm-long Si-waveguide, using lensed fiber-probes to couple light into/out of the Si-waveguide, without any SuperGRIN lens at both input/output ends. The plot 2300 shows the insertion-loss spectrum for random polarized light. As shown in the inset of FIG. 23, IR-light from a tunable IR-laser was coupled into the Si-waveguide 2302 through a lensed fiber-probe 2304a and out of the Si-waveguide 2302 through a lensed fiber-probe 2304b. The Si-waveguide 2302 has a thickness of about 300 nm. The average insertion loss of the 3 μm-wide Si-waveguide 2302 is about 27.6 dB. As the propagation power loss for the same length is about 5 dB, the coupling loss at the input is approximately 11.3 dB (i.e. [(27.6−5)/2]), by symmetry of the configuration.

FIG. 24 shows a plot 2400 of insertion-loss spectrum of a DUT 2401 including a 3 μm-wide Si-waveguide 2402 with a 500 μm-long Si-up-taper 2404 at the output and butt-terminated with a SuperGRIN lens 2406. A lensed fiber-probe 2408 was used for input coupling of a tunable IR-laser and an SMF28 2410 (with a core diameter, φ, of about 9 μm) was used for optical output coupling. The Si-waveguide 2402 has a thickness of about 300 nm. The inset of FIG. 24 shows an experimental set-up to measure the insertion loss, according to one embodiment.

The average insertion loss of the DUT 2401 was about 18.6 dB. The coupling loss from the output facet of the SuperGRIN lens 2406 to the SMF28 2410 was evaluated to be about 2.3 dB (i.e. 18.6 dB−5 dB(propagation)−11.3 dB(input-coupling loss)).

In various embodiments, as the Fresnel loss at the interface between the SuperGRIN lens 2406 and air was estimated as 2 dB, a coupling loss of about 0.3 dB for SuperGRIN 2406 to the SMF28 2410 may be attainable if the Fresnel loss is eliminated by, for example, using an anti-reflection coating.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An optical arrangement comprising:
a support substrate;
at least one optical fiber arranged on the support substrate;
at least one waveguide arranged on the support substrate and adjacent to the at least one optical fiber; the at least one waveguide defining a light propagation direction; and
at least one grin index lens arranged asymmetrically relative to the light propagation direction such that light is coupled from the at least one optical fiber through the at least one grin index lens to the at least one waveguide.

2. The optical arrangement of claim 1, wherein the at least one grin index lens comprises a multi-layer structure of at least two different layers with a difference in refractive index such that the at least one grin index lens is configured to allow a variation in the difference in refractive index to achieve a desired focus spot size so as to enable coupling of an optical mode in the at least one optical fiber to the at least one waveguide.

3. (canceled)

4. The optical arrangement of claim 2, wherein the at least two different layers include a combination of materials selected from a group consisting of silicon and silicon oxide, silicon and hafnium oxide, and silicon and titanium oxide.

5. The optical arrangement of claim 1, further comprising an insulating layer arranged on the support substrate.

6-8. (canceled)

9. The optical arrangement of claim 5, wherein the insulating layer is a buried oxide layer.

10. The optical arrangement of claim 1, wherein the at least one grin index lens comprises a parabolic or near-parabolic refractive index profile.

11. The optical arrangement of claim 1, wherein the at least one waveguide comprises an up-tapered waveguide.

12. The optical arrangement of claim 1, wherein the at least one waveguide comprises a decreasing cross-sectional dimension in a direction away from the at least one grin index lens.

13-15. (canceled)

16. The optical arrangement of claim 1, wherein the support substrate comprises at least one first groove.

17. The optical arrangement of claim 16, wherein the at least one optical fiber is positioned in the at least one first groove so as to allow an optical alignment of the at least one optical fiber to the at least one grin index lens.

18. (canceled)

19. The optical arrangement of claim 16, further comprising a capping substrate.

20. The optical arrangement of claim 19, wherein the capping substrate comprises at least one second groove.

21-22. (canceled)

23. The optical arrangement of claim 19, further comprising at least one interconnect arranged between the capping substrate and the support substrate, the at least one interconnect is configured to secure the at least one optical fiber in a desired position between the capping substrate and the support substrate.

24-25. (canceled)

26. The optical arrangement of claim 19, wherein the capping substrate comprises a metallic substrate.

27-28. (canceled)

29. The optical arrangement of claim 1, further comprising an electronics-photonics integrated circuit, wherein the at least one waveguide is optically coupled to the electronics-photonics integrated circuit.

30-32. (canceled)

33. A method of forming an optical arrangement, the method comprising:
forming at least one optical fiber on a support substrate;
forming at least one waveguide on the support substrate and adjacent to the at least one optical fiber;
forming at least one grin index lens asymmetrically relative to a light propagation direction within the at least one waveguide and further between the at least one optical fiber and the at least one waveguide such that light is coupled from the at least one optical fiber through the at least one grin index lens to the at least one waveguide.

34. The method of claim 33, wherein forming the at least one waveguide on the support substrate and adjacent to the at least one optical fiber comprises:
forming at least one waveguide layer on the support substrate; and
patterning the at least one waveguide layer to form the at least one waveguide.

35. The method of claim 34, wherein forming the at least one grin index lens comprises:
forming a first masking layer on at least one grin index lens structure;
forming a first photoresist layer with a desired pattern on the first masking layer;
patterning the desired pattern of the first photoresist layer onto the first masking layer; and
removing portions of the first masking layer and the at least one grin index lens structure not covered by the first photoresist layer.

36. The method of claim 35, wherein patterning the desired pattern of the first photoresist layer onto the first masking layer comprises dry etching by argon/chlorine reactive ion beam etching.

37-39. (canceled)

40. The method of claim 34, wherein forming the at least one grin index lens comprises:
forming a second photoresist layer with at least one opening on at least one grin index lens structure;
forming a second masking layer into the at least one opening; and
removing the second photoresist layer and portions of the at least one grin index lens structure not covered by the second masking layer.

41. The method of claim 40, wherein forming the second masking layer into the at least one opening comprises electroplating the second masking layer into the at least one opening.

42-43. (canceled)

44. The method of claim 35, wherein forming the at least one grin index lens further comprises forming the at least one grin index lens structure over the support substrate and in contact with the at least one waveguide.

45. The method of claim 44, wherein forming the at least one grin index lens structure over the support substrate and in contact with the at least one waveguide comprises depositing a plurality of a pair of two different layers with a difference in refractive index in an alternating sequence over the support substrate.

46. The method of claim 45, wherein removing portions of the first masking layer and the at least one grin index lens structure not covered by the first photoresist layer comprises etching using etchant gases with a substantially equal etch rate of the pair of two different layers.

47. The method of claim 45, wherein removing the second photoresist layer and portions of the at least one grin index structure not covered by the second masking layer comprises etching using etchant gases with a substantially equal etch rate of the pair of two different layers.

48. (canceled)

49. The method of claim 44, further comprising forming an etch stop layer over the support substrate.

50. The method of claim 49, further comprising providing heat treatment after depositing a first of the plurality of the pair of two different layers.

51. The method of claim 50, wherein providing heat treatment comprises performing rapid thermal annealing for silicidation of the first of the pair of two different layers with the etch stop layer.
